(19) United States
(12) Patent Application Publication
(10) Pub. No.: US 2026/0078225 A1
(43) Pub. Date: Mar. 19, 2026

(54) Polymerizable Compositions, Methods of Making a Polymer Using Same, and Products Thereof

(71) Applicant: Cornell University, Ithaca, NY (US)

(72) Inventors: Brett P. Fors, Ithaca, NY (US); Tristan H. Lambert, Lansing, NY (US); Yuting Ma, Ithaca, NY (US)

(21) Appl. No.: 19/109,503

(22) PCT Filed: Sep. 7, 2023
(86) PCT No.: PCT/US2023/073689

§ 371 Date: Mar. 6, 2025

Related U.S. Application Data
(60) Provisional application No. 63/404,429, filed on Sep. 7, 2022.

(51) Int. Cl. C08G 81/02; C09D 4/00; C09D 187/00

(52) U.S. Cl. CPC C08G 81/025; C09D 4/00; C09D 187/005

(57) ABSTRACT

Polymerizable compositions, polymerization methods, and articles of manufacture. In various examples, a polymerization method comprises first monomer(s); second monomer(s); first polymerization agent(s); second polymerization agent(s); and optionally, one or more hydrogen bond donor(s). In various examples, a polymerizable composition is suitable for use in a 3-D printing method, an additive manufacturing method, in a photocurable thermoset application, or any combination thereof. In various examples, a polymerization method comprises: irradiating a polymerizable composition with a first dosage of light, where at least a portion of the first monomer(s) is/are polymerized and substantially none the second monomer(s) is/are polymerized and irradiating the irradiated polymerization composition with a second dosage of light, where at least a portion of the second monomer is polymerized, and the first wavelength and the second wavelength are substantially the same. In various examples, an article of manufacture comprises thermoset polymer(s) of the present disclosure.

### CROSS-REFERENCE TO RELATED APPLICATIONS

This application claims the benefit of U.S. Provisional Patent Application No. 63/404,429, filed Sep. 7, 2022; the contents of the above-identified application are hereby fully incorporated herein by reference in their entirety.

### STATEMENT REGARDING FEDERALLY SPONSORED RESEARCH AND DEVELOPMENT

This invention was made with government support under grant no. CHE-2108598 awarded by the National Science Foundation. The government has certain rights in the invention.

### BACKGROUND OF THE DISCLOSURE

Photopolymerizations facilitate rapid and controllable polymer synthesis and their applications in additive manufacturing (AM) have enabled the fabrication of complex multi-materials. These multi-materials, with their spatially tunable properties, are highly desirable in electronics and soft robotics. However, typical multi-material synthesis requires multiple individual resins, causing material waste, lengthy manufacturing, and inter-material separation, limiting their production.

Wavelength-orthogonal processes have recently been developed to selectively cure dual materials from a single resin, but these strategies necessitate customized manufacturing systems and wavelength-specific photocatalysts. Additionally, a dual-catalyst initiated ring-opening metathesis polymerization to control the stereochemistry and mechanical properties of polyoctenamers with monochromatic light has been demonstrated. Still, expensive ruthenium-based catalysts are involved, and the material scope is limited to strained cyclic olefinic monomers. Therefore, a general synthetic strategy that can produce multi-materials in one pot using a single wavelength of light remains a highly desirable goal.

Photoinitiated free radical and cationic polymerizations are intensively used in photolithography, AM, and coating industries. Type I and II photoinitiators promote rapid radical polymerizations; meanwhile, photoacid generators (PAGs) such as “onium” salts, generate strong Bronsted acid for curing cationic monomers. Due to their uncontrolled characteristics, decoupling the two photoinitiated polymerizations in one pot with one wavelength of light has not been feasible.

Photoacid generators (PAGs) are a class of light-sensitive molecules that generate acids upon light exposure, inducing photoinitiated cationic polymerizations. Development in PAGs has enabled numerous applications in industries such as photolithography, photocurable coatings, adhesives, and 3D printing. To achieve efficient polymerizations on time scales for manufacturing, most PAGs contain non-coordinating anions that can form Bronsted superacids, such as SbF₆⁻ and PF₆⁻.While these strong acids facilitate rapid polymerization, the usage of these fluorine containing PAGs poses potential health hazards that limit the applications. PAGs with coordinating anions (e.g., Cl⁻) are often more benign but not commonly used, as they generate weak acids (e.g., HCl) that lead to polymerizations that are too slow for practical applications.

Discoveries of photoacid generators (PAGs) facilitated a number of technology breakthroughs in electronics, coating, and additive manufacturing industries. Traditionally, PAGs that contain non-coordinating anions are applied to generate Bronsted superacids for rapid cationic polymerizations. However, little research has investigated PAGs carrying coordinating anions. Because these PAGs only produce weak acids once photoexcited, initiating cationic polymerizations with these PAGs is not efficient.

### SUMMARY OF THE DISCLOSURE

The present disclosure provides, inter alia, polymerizable compositions and polymerization methods. The present disclosure also provides articles of manufacture. Non-limiting examples of the compositions, the methods and products thereof, and the articles of manufacture are provided herein.

In various examples, a polymerization method comprises: irradiating a polymerizable composition comprising: one or more first monomer(s); one or more second monomer(s); one or more first polymerization agent(s); one or more second polymerization agent(s); and optionally, one or more hydrogen bond donor(s), with a first dosage of light comprising a first wavelength of light, where at least a portion of the first monomer(s) is/are polymerized and substantially none or none the second monomer(s) is/are polymerized. In various examples, the method further comprising irradiating the irradiated polymerization composition with a second dosage of light comprising a second wavelength of light, wherein at least a portion of the second monomer is polymerized, and the first wavelength and the second wavelength are substantially the same. In various examples, i) the pH of the polymerizable composition comprises a first pH prior to and/or during the irradiating of the polymerizable composition and/or a second pH prior to and/or during the irradiating of the irradiated polymerizable composition, and the first pH is different than the second pH; or ii) the pH of the polymerizable composition comprises a first pH prior to the irradiating of the polymerizable composition, a second pH during or after irradiating of the polymerizable composition, and a third pH during or after the irradiating of the irradiated polymerizable composition, wherein the first pH, second pH, and third pH are all different. In various examples, the polymerization of the first monomer is a radical polymerization or a cationic polymerization, or the like. In various examples, the first polymerization agent(s) is/are chosen from photosensitizers, photoacid generators, and the like, and any combination thereof. In various examples, one or more or all of the first polymerization agent(s) comprise one or more coordinating anion(s). In various examples, the one or more coordinating anion(s) is/are chosen from halides, pentacarbomethoxycyclopentadienes (PCCP⁻s), carboxylates, structural analogs thereof, and the like, and any combination thereof. In various examples, the first monomer(s) is/are chosen from radical polymerization monomers, cationic polymerization monomers, and the like, and any combination thereof. In various examples, the polymerization of the second monomer is a cationic polymerization or the like. In various examples, the second polymerization agent(s) is/are chosen from photoacid generators and the like, and any combination thereof. In various examples, one or more or all of the photoacid generator(s) comprise one or more non-coordinating anion(s). In various examples, the polymerizable composition further comprises one or more salt(s), each salt comprising one or more coordinating anion(s). In various examples, the mole ratio of coordinating anion(s) to photoacid generator(s) is about 1:1 to about 0.01:1. In various examples, the second monomer(s) is/are chosen from cationic polymerization monomers and any combination thereof. In various examples, the polymerizable composition comprises one or more crosslinking monomer(s). In various examples, i) the first monomer(s) is/are chosen from radical polymerization monomers and any combination thereof and/or the first polymerization agent(s) is/are chosen from photosensitizers any combination thereof, and/or the first monomer is polymerized by a radical polymerization, and/or the second monomer(s) is/are chosen from cationic polymerization monomers and any combination thereof and/or the second polymerization agent comprises a photoacid generator or photoacid generators and/or the second monomer is polymerized by a cationic polymerization; ii) the wherein the first monomer(s) is/are chosen from cationic polymerization monomers and any combination thereof and/or the first polymerization agent comprises a photoacid generator or photoacid generators and coordinating anion(s) and/or organic salts/inorganic salts comprising one or more coordinating anion(s) and/or the first monomer is polymerized by a cationic polymerization, and/or the second monomer(s) is/are chosen from cationic monomers and any combination thereof and/or the second polymerization agent comprises a photoacid generator or photoacid generators each comprising one or more non-coordinating anion(s) and/or the second monomer is polymerized by a cationic polymerization. In various examples, the polymerizable composition further comprises one or more chain transfer agent(s), the method further comprises functionalizing the polymer product formed as a result of the irradiating of the polymerizable composition and/or irradiation of the irradiated polymerizable composition.

In various examples, a polymerizable composition comprises: one or more first monomer(s); one or more second monomer(s); one or more first polymerization agent(s); one or more second polymerization agent(s); and optionally, one or more hydrogen bond donor(s). In various examples, the first monomer(s) is/are chosen from radical polymerization monomers, cationic polymerization monomers, and the like, and any combination thereof. In various examples, the radical polymerization monomer(s) is/are chosen from acrylates, methacrylates, acrylamides, vinyl carboxylates, styrenes, structural analogs thereof, and the, and any combination thereof. In various examples, the cationic polymerization monomer(s) is/are chosen from vinyl ethers, epoxides, lactones, cyclic acetals, heterocyclic acetals, structural analogs thereof, and the like, and any combination thereof. In various examples, the first polymerization agent(s) is/are chosen from photosensitizers, photoacid generators, and the like, and any combination thereof. In various examples, the photosensitizer(s) is/are chosen from thioflavin T, riboflavin, diphenyl (2,4,6-trimethylbenzoyl) phosphine oxide, acridine orange, Rose Bengal, H-Nu470, champhorquinone, zinc tetraphenylporphyrin, structural analogs thereof, and the like, and any combination thereof. In various examples, the photoacid generator(s) is/are chosen from triarylsulfonium salts, diaryliodonium salts, structural analogs thereof, and the like, and any combination thereof. In various examples, one or more or all of the photoacid generator(s) comprise one or more coordinating anion(s). In various examples, the one or more coordinating anion(s) are chosen from halides, pentacarbomethoxycyclopentadienes (PCCP⁻s), carboxylates, structural analogs thereof, and the like, and any combination thereof. In various examples, the second monomer(s) is/are chosen from cationic polymerization monomers and any combination thereof. In various examples, cationic polymerization monomer(s) is/are chosen from epoxides, lactones, cyclic acetals, heterocyclic acetals, structural analogs thereof, and the like, and any combination thereof. In various examples, in the second polymerization agent(s) is/are chosen from photoacid generators (which, independently, may comprise one or more non-coordinating anion(s)), and the like, and any combination thereof. In various examples, one or more or all of the photoacid generator(s) comprise one or more non-coordinating anion(s). In various examples, the one or more non-coordinating anion(s) are chosen from PF₆⁻, SbF₆⁻, ClO₄⁻, CF₃SO₃⁻, structural analogs thereof, and the like, and any combination thereof. In various examples, one or more or all the second polymerization agent(s) is/are a photoacid generator (e.g., a photoacid generator comprising one or more non-coordinating anion(s)), the composition further comprises one or more salt(s), each salt comprising one or more coordinating anion(s). In various examples, the coordinating anions are chosen from halides, pentacarbomethoxycyclopentadienes (PCCP⁻s), carboxylates, structural analogs thereof, and any combination thereof. In various examples, the mole ratio of coordinating anion(s) to photoacid generator(s) is about 1:1 to about 0.01:1. In various examples, the one or more salt(s) is/are chosen from a tetraalkylammonium salts comprising one or more coordinating anion(s). In various examples, the polymerizable composition further comprises one or more crosslinking monomer(s). In various examples, the polymerizable composition further comprises one or more chain transfer agent(s). In various examples, the polymerizable composition further comprises one or more solvent(s). In various examples, the composition is suitable for use in a 3-D printing method, an additive manufacturing method, in a photocurable thermoset application, or any combination thereof.

### BRIEF DESCRIPTION OF THE FIGURES

For a fuller understanding of the nature and objects of the disclosure, reference should be made to the following detailed description taken in conjunction with the accompanying figures.

FIG. 1 shows switching polymerization mechanisms using photobuffer. (A) Nonselective photoinitiated radical and cationic polymerizations without photobuffer (B) One pot switching radical and cationic polymerizations with photobuffer (C) Spatial control of multi-material properties with monochromatic light.

FIG. 2 shows switching radical and cationic polymerizations using photobuffer. (A) Photobuffer Cl⁻ delays the strong acid HSbF₆ generation under short light pulse, allowing radical polymerization to proceed before cationic polymerization. (B) Without photobuffer, both MA radical polymerization and CHO cationic polymerization were initiated. (C) With 1 equiv of TBACl, only MA was consumed under short 10 min light pulse. (D) With 1 equiv of TBACl and long 60 min light pulse, both MA and CHO were polymerized.

FIG. 3 shows multi-material synthesis using SPLiT. (A) Acrylate-epoxide resins contain photoinitiators, photobuffer, monomers, and crosslinkers. (B) Stress-strain curves of crosslinked acrylate-epoxide films made with short (30 s) and long (1 hour) blue light irradiation. Short irradiation produced soft thermoset (E=0.7 MPa), while long irradiation produced stiffer thermoset (E=367 MPa). (C) A variety of photo buffers (TBACl, TBAPCCP, TBAOAc, TBABr) were applied to acrylate-epoxide resins and all afforded soft films under short light irradiation, and hard films under long light irradiation. (D) Varying MA:TEGDA ratios altered acrylate-epoxide thermoset Young's modulus independently under short light pulse. (E) Varying epoxy equivalences (both monomers and crosslinkers) tuned thermoset Young's modulus independently under long light pulse.

FIG. 4 shows spatial control of multi-material properties using SPLiT. (A) A soft acrylate thermoset was formed upon short light pulse, applying a photomask under long light pulse yielded an acrylate-epoxide thermoset with spatially hard and soft domains. (B) Middle region of an acrylate-epoxide resin irradiated with long light pulse had a storage modulus G′ of 27.7 MPa, while the outer regions exposed to short light pulse had a G′ of 1.09 MPa. (C) A photopatterned dogbone film was subjected to cyclic tensile testing, where domains exposed to short pulse were soft and stretchy.

FIG. 5 shows switching two cationic polymerizations using SPLiT. (A) Weak acid generation under short light pulse initiates IBVE cationic polymerizations, while long pulse induces strong acid generation, which polymerizes caprolactones. (B) Only IBVE was cationically consumed under short pulse, while both IBVE and CL were cationically consumed under long pulse. (C) Short pulse afforded a thermoset with a storage modulus of 59 kPa, while long pulse gave a harder thermoset with a storage modulus of 518 kPa.

FIG. 6 shows a photograph of experimental setup for spatial control of thermoset properties.

FIG. 7 shows tensile Testing Results in FIG. 3C. (A) TBACL. (B) TBAPCCP. (C) TBABr. (D) TBAOAc.

FIG. 8 shows tensile Testing Results for FIG. 3D. (A) 100:1 MA:TEGDA. (B) 90:10 MA:TEGDA. (C) 70:30 MA:TEGDA

FIG. 9 shows tensile Testing Results for FIG. 3E. (A) 5 equiv epoxide. (B) 10 equiv epoxide. (C) 20 equiv epoxide. (D) 40 equiv epoxide.

FIG. 10 shows representative GC-FID chromatograms of supernatants from films that were irradiated for 0 s, 30 s, and 60 m.

FIG. 11 shows average peak areas of CHO and anisole vs. irradiation time.

FIG. 12 shows (A) cyclic tensile testing result for photopatterned dogbone film and (B) cyclic tensile testing result for photopatterned dogbone film.

FIG. 13 shows photopatterned crosslinked acrylate-epoxide dogbone film.

FIG. 14 shows DMA results for spatial control over crosslinked acrylate-epoxide film in FIG. 4B.

FIG. 15 shows rheological test results for crosslinked vinyl ether-lactone film in FIG. 5C.

FIG. 16 shows a scheme of HBD catalyzed photoinitiated polymerizations for PAGs containing non-coordinating anions.

FIG. 17 shows, upon addition of HBD, photopolymerization with PAG-PCCP was observed.

FIG. 18 shows photopolymerization kinetics of IBVE with and without HBD using PAGs with anions resulting in acids with various pKas. Without HBD, only PAG-OTf and PAG-PF₆ resulted in polymerization. The other anions required the addition of HBD to initiate within 2 hours.

FIG. 19 shows titration of HBD with various anions in the form of TBA salts was tracked by ¹H-NMR. The N—H protons on the HBD shifted downfield that fit the model for 1:1 binding in TBA-Cl, NO₃, TsO, and Br.

FIG. 20 shows differences in geometry of the coordinating anion could lead to differences in rate acceleration.

FIG. 21 shows photopolymerizations still occur in air, with PAG-TsO exhibiting the least reduction in rate.

FIG. 22 shows other vinyl ethers were polymerized with PAG-Cl and HBD.

FIG. 23 shows HBD allowed for initiation of IBVE polymerization with HCl, giving control when a CTA was added.

FIG. 24 shows GPC traces of polymerization kinetics with PAG-OTf without HBD.

FIG. 25 shows GPC traces of polymerization kinetics with PAG-PF₆ without HBD.

FIG. 26 shows GPC traces of polymerization kinetics with PAG-OAc and HBD.

FIG. 27 shows GPC traces of polymerization kinetics with PAG-PCCP and HBD.

FIG. 28 shows GPC traces of polymerization kinetics with PAG-Cl and HBD.

FIG. 29 shows GPC traces of polymerization kinetics with PAG-NO₃ and HBD.

FIG. 30 shows GPC traces of polymerization kinetics with PAG-pTsO and HBD.

FIG. 31 shows GPC traces of polymerization kinetics with PAG-OTf and HBD.

FIG. 32 shows GPC traces of polymerization kinetics with PAG-PF₆ and HBD.

FIG. 33 shows GPC traces of EVE polymerization kinetics with PAG-Cl and HBD.

FIG. 34 GPC traces of NBVE polymerization kinetics with PAG-Cl and HBD.

FIG. 35 shows GPC traces of NBVE polymerization kinetics with PAG-Cl and HBD.

### DETAILED DESCRIPTION OF THE DISCLOSURE

Although claimed subject matter will be described in terms of certain examples and embodiments, other examples and embodiments, including examples that do not provide all of the benefits and features set forth herein, are also within the scope of this disclosure. Various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent radicals and multivalent radicals, such as, for example, divalent radicals, trivalent radicals, and the like). Illustrative examples of groups include:

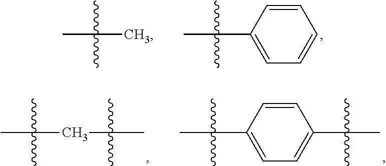

and the like.

As used herein, unless otherwise indicated, the term “alkyl” or “alkyl group” refers to branched or unbranched hydrocarbon groups that include only single bonds between carbon atoms. In various examples, an alkyl group is a C₁ to C₂₀ alkyl group, including all integer numbers of carbons and ranges of numbers of carbons therebetween (e.g., a C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). In various examples, an alkyl group is a saturated group. In various examples, an alkyl group is a cyclic alkyl group, e.g., a monocyclic alkyl group or a polycyclic alkyl group. Examples of alkyl groups include, but are not limited to, methyl groups, ethyl groups, propyl groups, butyl groups, isopropyl groups, tert-butyl groups, benzyl groups, cyclohexyl groups, adamantyl groups, and the like. In various examples, an alkyl group is unsubstituted or substituted with one or more substituent(s). Examples of substituents include, but are not limited to, various substituents such as, for example, halide groups (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, hydroxyl groups, amine groups, nitro groups, cyano groups, isocyano groups, silyl groups, alkoxide groups, alcohol groups, ether groups, ketone groups, carboxylate groups, carboxylic acid groups, ester groups, amide groups, thioether groups, and the like, and any combination thereof

As used herein, unless otherwise indicated, the term “aryl” or “aryl group” refers to C₅ to C₃₀ aromatic or partially aromatic carbocyclic groups, including all integer numbers of carbons and ranges of numbers of carbons therebetween (e.g., C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, and C₃₀). Aryl groups may comprise polyaryl groups such as, for example, fused ring groups, biaryl groups, or the like, or any combination thereof. The aryl group may be unsubstituted or substituted with one or more substituent(s). Examples of substituents include, but are not limited to, substituents such as, for example, halide groups (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, hydroxyl groups, amine groups, nitro groups, cyano groups, isocyano groups, silyl groups, alkoxide groups, alcohol groups, ether groups, ketone groups, carboxylate groups, carboxylic acid groups, ester groups, amide groups, thioether groups, and the like, and any combination thereof. Aryl groups may contain hetero atoms, such as, for example, oxygen, nitrogen (e.g., pyridinyl groups and the like), sulfur, and the like, and any combination thereof. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, and the like.

As used herein, the term “structural analog” refers to a compound, a polymer, or group that can be envisioned by one of ordinary skill in the art to arise from another compound or group, respectively, if one atom or group of atoms, functional groups, or substructures is replaced with another atom or group of atoms, functional groups, substructures, or the like. In various examples, the term “structural analog” refers to any compound, monomer, polymer, polymerization product, or the like, or any portion thereof (such as, for example, one or more group(s) thereof or the like) or group if one atom or group of atoms, functional group or functional groups, or substructure or substructures is/are replaced with another atom or group of atoms, functional group or functional groups, substructure or substructures, or the like. In various examples, the term “structural analog” refers to any group that is derived from an original compound, monomer, polymerization product, or the like or portion thereof (such as, for example, one or more group(s) thereof or the like) or the like by a chemical reaction, where the compound, monomer, polymerization product, or the like or portion thereof (such as, for example, one or more group(s) thereof or the like) or the like is modified or partially substituted such that at least one structural feature of the compound, monomer, polymerization product, or the like or portion thereof (such as, for example, one or more group(s) thereof or the like) or the like is retained.

The present disclosure provides, inter alia, polymerizable compositions and polymerization methods and polymer products. The present disclosure also provides articles of manufacture.

In an aspect, the present disclosure provides polymerizable compositions. In various examples, a polymerizable composition is a thermoset resin (e.g., a photocurable thermoset resin) or the like. In various examples, a polymerization composition is used in a polymerization method of the present disclosure. Non-limiting examples of polymerizable compositions are described herein.

In various examples, a polymerizable composition comprises (consists essentially of or consists of) one or more first monomer(s); one or more second monomer(s); one or more first polymerization agent(s); one or more second polymerization agent(s), and optionally, one or more hydrogen bond donor(s). The first monomer(s) and second monomer(s) are structurally distinct and/or polymerize by different mechanisms. In various examples, the first polymerization agent is one or more photoacid generator(s), each comprising one or more non-coordinating anion(s), and the polymerization composition comprises one or more salt(s), each comprising one or more coordinating anion(s) (e.g., in about a stoichiometric amount relative to the photoacid generator(s). In various examples, the polymerizable composition further comprises one or more crosslinkers and/or one or more solvent(s).

Various first monomers can be used. Combinations of first monomers may be used. In various examples, first monomer(s) is/are chosen from radical polymerization monomers, cationic polymerization monomers, and the like, and any combination thereof. Non-limiting examples of radical polymerization monomers include acrylates, methacrylates, acrylamides (such as, for example, N,N-Dimethylacrylamide and the like), vinyl carboxylates (such as, for example, vinyl acetate and the like), styrenes, structural analogs thereof, and the like, and any combination thereof. Non-limiting examples of cationic polymerization monomers include vinyl ethers, epoxides, lactones, cyclic acetals (e.g., heterocyclic acetals, such as, for example, dioxolane and the like), structural analogs thereof, and the like, and any combination thereof.

Various second monomers can be used. Combinations of second monomers may be used. In various examples, second monomer(s) is/are chosen from cationic polymerization monomers, and the like, and any combination thereof. Non-limiting examples of cationic polymerization monomers include epoxides, lactones, cyclic acetals (e.g., heterocyclic acetals, such as, for example, dioxolane and the like), structural analogs thereof, and the like, and any combination thereof.

Various first polymerization agents can be used. Combinations of polymerization units may be used. In various examples, a first polymerization agent is a photoinitiator or the like. In various examples, a first polymerization agent does not comprise fluorine. In various examples, first polymerization agent(s) is/are chosen from photosensitizers, photoacid generators (which may, independently, comprise one or more coordinating anion(s)). In various examples, a photosensitizer or a photoacid generator is an organic salt comprising coordinating anion(s), inorganic soluble salts comprising coordinating anion(s), or the like. In various examples, a first polymerization agent does not comprise fluorine.

Non-limiting examples of photosensitizers include thioflavin T, riboflavin, diphenyl (2,4,6-trimethylbenzoyl) phosphine oxide, acridine orange, Rose Bengal, H-Nu470, champhorquinone, zinc tetraphenylporphyrin, structural analogs thereof, and the like, and any combination thereof. Non-limiting examples of photoacid generators ions include triarylsulfonium salts (such as, for example, tetraphenylsulfonium salts and the like), diaryliodonium salts (such as, for example, diphenyliodonium salts and the like), structural analogs thereof, and the like, and any combination thereof. Non-limiting examples of coordinating anions include halides (such as, as for example, Cl⁻, Br⁻, I⁻, and the like), pentacarbomethoxycyclopentadienes (PCCP⁻s), carboxylates (such as, for example, acetate OAc⁻, and the like), structural analogs thereof, and the like, and any combination thereof.

Various amounts of first polymerization agent(s) can be used. In various examples, a polymerization composition comprises about 0.5 weight percent (wt. %) to about 10 wt. % (based on the total weight of the polymerization composition) of first polymerization agent(s), including all 0.1 wt. % values and ranges therebetween (e.g., about 1 wt. % to about 10 wt. %).

Various second polymerization agents can be used. Combinations of polymerization agents may be used. In various examples, a second polymerization agent is a photoinitiator or the like. In various examples, second polymerization agent(s) is/are chosen from photoacid generators (which, independently, may comprise one or more non-coordinating anion(s)), or the like, or any combination thereof. In the case where a second polymerization agent is a photoacid generator, a polymerizable composition further comprises one or more coordinating anion(s). In various examples, a second polymerization agent does not comprise fluorine. In various examples, no first polymerization agent(s) nor any second polymerization agent(s) comprise fluorine. is a photoinitiator or the like.

In various examples, a PAG comprises (or the anion(s) of the PAG salt(s) is/are) a non-coordinating anion/non-coordinating anions. Non-limiting examples of non-coordinating 5 anions include PF₆⁻, SbF₆⁻, ClO₄⁻, CF₃SO₃⁻, structural analogs thereof, and the like, and any combination thereof.

Various amounts of second polymerization agent(s) can be used. In various examples, a polymerization composition comprises about 0.5 weight percent (wt. %) to about 10 wt. % (based on the total weight of the polymerization composition) of second polymerization agent(s), including all 0.1 wt. % values and ranges therebetween (e.g., 1 weight percent (wt. %) to about 10 wt. %.

In the case where a second polymerization agent is a photoacid generator (e.g., a photoacid generator comprising one or more non-coordinating anion(s)), a polymerizable composition may further comprise one or more salt(s), each salt comprising one or more coordinating anion(s). Non-limiting examples of salts comprising one or more coordinating anion(s) include organic salts comprising coordinating anion(s), inorganic soluble salts comprising coordinating anion(s), and the like, and any combination thereof. Non-limiting examples of coordinating anions include halides (such as, as for example, Cl⁻, Br⁻, I⁻, and the like), pentacarbomethoxycyclopentadienes (PCCP⁻s), carboxylates (such as, for example, acetate OAc⁻, and the like), and the like, and any combination thereof. In various examples, a polymerizable composition comprises a tetraalkylammonium salt comprising one or more coordinating anion(s) (such as, for example, tetrabutylammonium (TBA) salt and the like), or the like, or any combination thereof. In various examples, the cation of a coordinating anion is a tetraalkylammonium cation (such as, for example, tetrabutylammonium cation and the like), or the like, or any combination thereof.

In various examples, a polymerizable composition comprises a photobuffer or the like. In various examples, a photobuffer comprises (or is formed from) one or more photoacid generator(s) comprising a non-coordinating anion/non-coordinating anions and one or more salt(s) comprising coordinating anion(s). When a polymerizable composition comprises one or more photobuffer(s), a composition may comprise one or more coordinating ion(s).

In various examples, a polymerizable composition comprises about a stoichiometric amount or less of coordinating anion(s) (which may be relative to the amount of photoacid generator(s) (e.g., photoacid generator(s) comprising non-coordinating anion(s)). In various examples, the mole ratio of coordinating anion(s) to photoacid generator(s) comprising a non-coordinating anion/non-coordinating anions is about 1:1 or less (e.g., about 1:1 to about 0.01:1). In various examples, the mole ratio of coordinating anion(s) to non-coordinating anion(s) is about 1:1 or less (e.g., about 1:1 to about 0.01:1).

Various hydrogen bond donors (HBDs) may be used. Combinations of hydrogen bond donors may be used. Without intending to be bound by any particular theory, it is considered a HBD donates electron density to (e.g., such that it forms a hydrogen bond with) an anion (e.g., a coordinating or a non-coordinating anion). It is considered this decreases the anion basicity and may facilitate cationic polymerizations. In various example, hydrogen bond donor(s) is/are chosen from thiophosphoramides, sulfamides, structural analogs thereof, and the like, or any combination thereof.

In various examples, a thiophosphoramide is a N-aryl substituted thiophosphoramide (such as, for example, a tri-N-aryl substituted thiophosphoramide or the like) or the like. In various examples, a thiophosphoramide comprises the following structure:

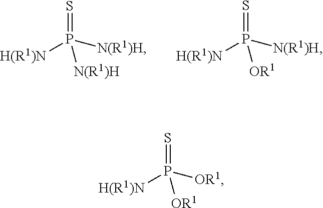

where R¹ is independently at each occurrence chosen from aryl groups (such as, for example, phenyl groups) and the like.

In various examples, a sulfamide comprises the following structure:

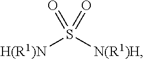

where R¹ is independently at each occurrence chosen from aryl groups (such as, for example, phenyl groups) and the like.

Various amounts of hydrogen bond donor(s) can be used. In various examples, a polymerization composition comprises about 0.1 times to about 10 times the amount of the first polymerization agent and/or the second polymerization agent, including all 0.05 times values and ranges therebetween. In various examples, a polymerization composition comprises about 0.5 weight percent (wt. %) to about 10 wt. % (based on the total weight of the polymerization composition) of hydrogen bond donor(s), including all 0.1 wt. % values and ranges therebetween.

In various examples, a polymerizable composition further comprises one or more cross-linking monomer(s). Non-limiting examples of crosslinking monomers include acrylate crosslinkers (such as, for example, tetraethylene glycol diacrylate (TEDGA), 1,4-butanediol diacrylate (BDA), and the like), methacrylate crosslinkers, structural analogs thereof, and the like, and any combination thereof.

In various examples, a polymerizable composition further comprises one or more chain transfer agent(s) (such as, for example, RAFT polymerization agent(s) or the like, or any combination thereof). Non-limiting examples, of RAFT polymerization chain transfer agents include trithiocarbonate (S-1-isobutoxylethyl S′-ethyl trithiocarbonate)

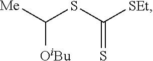

dithiocarbamate (S-1-isobutoxyethyl N,N-diethyl dithiocarbamate)

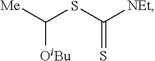

structural analogs thereof, and the like, and any combination thereof.

In various examples, a polymerizable composition further comprises one or more solvent(s). Combinations of solvents may be used. Non-limiting examples of solvents include chlorinated hydrocarbons (e.g., dichloromethane (DCM), dichloroethane (DCE), and the like), alkanes (e.g., hexanes, cyclohexane, and the like), ethers (diethyl ether, cyclopentyl methyl ether (CPME), and the like), aromatic hydrocarbons (toluene and the like), and the like, and any combination thereof.

A polymerizable composition can have different forms. In various examples, a polymerizable composition is a film, a sheet, or the like.

Polymerization compositions can have various uses. In various examples, a composition is suitable for use in a photolithography method, a 3-D printing method, an additive manufacturing method, in a photocurable thermoset application (such as, for example, as a coating or the like), or the like, or any combination thereof. In various examples, a polymerizable composition is a photoresist or the like or a photoresist comprises a polymerizable composition.

In an aspect, the present disclosure provides polymerization methods. In various examples, a method comprises photoswitching from a first polymerization method to a different and second polymerization method. In various examples, a method comprises Switching Polymerizations by Light Titration (SPLiT). In various examples, a method comprises use of a polymerizable composition of the present disclosure. In various examples, a polymerization product (such as, for example, a thermoset polymer or the like) is made by a method of the present disclosure. Non-limiting examples of polymerization methods are described herein.

In various examples, a polymerization method comprises use of single wavelength (which may be provided by a single source or multiple sources) at different time periods and/or intensities, which results in switching between polymerization mechanisms. In various examples, a polymerization comprises the selective polymerizations of two different monomers (such as, for example, acrylate(s) and epoxide(s)) by two different polymerization mechanisms ((such as, for example, a radical polymerization and a cationic polymerization, respectively) in one pot.

In various examples, a method for switching between polymerization mechanisms comprises adding about a stochiometric amount of a relatively basic anion (compared to the anion, which may be a non-coordinating anion, of the photoacid generator) to buffer the acid generation, thereby allowing radical polymerizations to proceed before cationic polymerizations. In various examples, a TBA salt comprising a coordinating anion is (e.g., or organic and inorganic soluble salt(s) with coordinating anions is/are) added to the polymerizable composition to buffer the acid generation, which results in photoswitchable radical and cationic polymerizations under different PH values (weak acid environment at a first pH value under short time exposure to light and strong acid environment at a second pH value under longer time exposure to light).

In various examples, a polymerization method comprises: irradiating a polymerizable composition of the present disclosure (e.g., a polymerizable composition comprising: one or more first monomer(s); one or more second monomer(s); one or more first polymerization agent(s) (which may be a photoinitiator/photoinitiators); and one or more second polymerization agent(s) (which may be a photoinitiator/photoinitiators), and optionally, one or more hydrogen bond donor(s)) with a first dosage of light comprising a first wavelength of light (e.g., the first irradiating/irradiation). In various examples, at least a portion of the first monomer(s) is/are polymerized and/or substantially none or none the second monomer(s) is/are polymerized (e.g., the first polymerization). In various examples, the polymerization method further comprises irradiating the polymerizable composition that was irradiated with the first dosage of light with a second dosage of light comprising a second wavelength of light (e.g., the second irradiating/irradiation, where at least a portion of the second monomer(s) is/are polymerized (e.g., the second polymerization) and/or substantially none or none the first monomer(s) is/are polymerized as a result of the irradiation with the second dosage of light.

In various examples, a first irradiation and a second irradiation each form two distinct (e.g., structurally and/or compositionally distinct) polymer materials (e.g., collectively a polymerization product, such as, for example, a thermoset material). In various examples, the two distinct (e.g., structurally and/or compositionally distinct) polymers are crosslinked (which may form a network). In various examples, the two distinct (e.g., structurally and/or compositionally distinct) polymers are produced in a single reaction vessel. In various examples, the two distinct (e.g., structurally and/or compositionally distinct) polymers are produced in a single reaction vessel without separating, isolating, or the like, the first polymer material prior to the second irradiation or formation of the second polymer product.

In various examples, a polymerization method (e.g., the first polymerization and second polymerization) forms a thermoset polymer material (which may be a crosslinked thermoset polymer material or the like). In various examples, a thermoset polymer material (which may be a crosslinked thermoset polymer material) comprises at least two different polymers. In various examples, a thermoset polymer material comprises or is an acrylate-epoxide thermoset polymer material, methacrylate-epoxide thermoset polymer material, acrylamide-epoxide thermoset polymer material, vinyl carboxylate-epoxide thermoset polymer material, styrene-epoxide thermoset polymer material, acrylate-lactone thermoset polymer material, methacrylate-lactone thermoset polymer material, acrylamide-lactone thermoset polymer material, vinyl carboxylate-lactone thermoset polymer material, styrene-lactone thermoset polymer material, acrylate-cyclic acetal thermoset polymer material, methacrylate-cyclic acetal thermoset polymer material, acrylamide-cyclic acetal thermoset polymer material, vinyl carboxylate-cyclic acetal thermoset polymer material, styrene-cyclic acetal thermoset polymer material, vinyl ether-epoxide thermoset polymer material, vinyl ether-lactone thermoset polymer material, vinyl ether-cyclic acetal thermoset polymer material. In various examples, a thermoset polymer material comprises or is an acrylate-epoxide network, methacrylate-epoxide network, acrylamide-epoxide network, vinyl carboxylate-epoxide network, styrene-epoxide network, acrylate-lactone network, methacrylate-lactone network, acrylamide-lactone network, vinyl carboxylate-lactone network, styrene-lactone network, acrylate-cyclic acetal network, methacrylate-cyclic acetal network, acrylamide-cyclic acetal network, vinyl carboxylate-cyclic acetal network, styrene-cyclic acetal network, vinyl ether-epoxide network, vinyl ether-lactone network, vinyl ether-cyclic acetal network, an acrylate-epoxide crosslinked network, methacrylate-epoxide crosslinked network, acrylamide-epoxide crosslinked network, vinyl carboxylate-epoxide crosslinked network, styrene-epoxide crosslinked network, acrylate-lactone crosslinked network, methacrylate-lactone crosslinked network, acrylamide-lactone crosslinked network, vinyl carboxylate-lactone crosslinked network, styrene-lactone crosslinked network, acrylate-cyclic acetal crosslinked network, methacrylate-cyclic acetal crosslinked network, acrylamide-cyclic acetal crosslinked network, vinyl carboxylate-cyclic acetal crosslinked network, styrene-cyclic acetal crosslinked network, vinyl ether-epoxide crosslinked network, vinyl ether-lactone crosslinked network, vinyl ether-cyclic acetal crosslinked network, or the like, or any combination thereof.

In various examples, a polymerization method comprises (or consists essentially of or consists of): irradiating a polymerizable composition (e.g., a first irradiation) comprising: one or more first monomer(s); one or more second monomer(s); a first polymerization agent (which may be a photoinitiator/photoinitiators); and a second polymerization agent (which may be a photoinitiator/photoinitiators), with a first dosage (e.g., a first pulse) of light comprising a first wavelength of light (e.g., to initiate a first polymerization), where at least a portion of the first monomer is polymerized and substantially none or none the second monomer(s) is/are polymerized, and, optionally, irradiating the irradiated polymerization composition with a second dosage (e.g., a first pulse) of light comprising (or is) a second wavelength of light (e.g., a second irradiation), where at least a portion of the second monomer(s) is polymerized and substantially none or none the first monomer, if present, is polymerized (e.g., polymerized by the irradiating of the irradiated polymerization composition), where the first wavelength and the second wavelength are substantially the same or the same.

In various examples, polymerization of first monomer(s) is/are a radical polymerization, a cationic polymerization, or the like. In various examples, polymerization of second monomer(s) is/are a cationic polymerization, or the like. In various examples, polymerization of the first monomer(s) is/are a radical polymerization, a cationic polymerization, or the like and polymerization of the second monomer(s) is/are a cationic polymerization, or the like.

Various polymerizable compositions of the present disclosure can be used. In various examples, the first polymerization agent(s) comprise, independently, one or more coordinating anion(s), and/or the second polymerization agent(s) comprise, independently, one or more non-coordinating anion(s). In various examples, a polymerizable composition does not comprise fluorine. In various examples, no first polymerization agent(s) nor any second polymerization agent(s) comprise fluorine.

Without intending to be bound by any particular theory, it is considered that the coordinating anion(s) in a polymerizable composition (which may be referred to a photobuffer) buffers the number of protons present in the polymerizable composition after the irradiation (e.g., first irradiation) and/or inhibits, substantially prevents, or prevents, for example, cationic polymerization or the like, under relatively short irradiation (e.g., first irradiation). In various example, the first pH is different (e.g., higher) before and during the irradiation of the polymerizable composition than during or after irradiation of the irradiated the second pH, such that polymerization (e.g., cationic polymerization) of the second monomer(s) is inhibited, substantially prevented, or prevented. In various examples, a polymerizable composition comprises a photobuffer comprising (or formed from) one or more photoacid generator(s) comprising a non-coordinating anion and one or more coordinating anion(s).

In various examples, the pH of the polymerizable composition comprises a first pH prior to and/or during the irradiating of the polymerizable composition and/or a second pH prior to and/or during the irradiating of the irradiated polymerizable composition, and the first pH is different (e.g., higher) (or substantially different) than the second pH; or ii) the pH of the polymerizable composition comprises a first pH prior to the irradiating of the polymerizable composition, a second pH during or after irradiating of the polymerizable composition, and a third pH during or after the irradiating of the irradiated polymerizable composition, where the first pH, second pH, and third pH are all substantially different (or different).

The light can provided by various sources. Suitable light sources are commercially available. The light can comprise (or have) a wavelength (which may be about a single wavelength) of about 365 nm, about 405 nm, about 530 nm, about 470 nm, about 615 nm, or the like. The polymerization agent(s) each absorb at least a portion of the light (e.g., the wavelength of light). In various illustrative examples, the corresponding photosensitizer(s)/wavelength(s) is/are used: thioflavin T for about 365 nm light, riboflavin or diphenyl (2,4,6-trimethylbenzoyl) phosphine oxide for about 405 nm light, acridine orange or Rose Bengal for about 530 nm, H-Nu470 or champhorquinone for about 470 nm, zinc tetraphenylporphyrin for about 615 nm light.

In various examples, a first dosage of light interacts with at least a first polymerization agent or all first polymerization agents resulting in polymerization of at least a portion or all first monomer(s). In various examples, a first dosage of light comprises a first irradiation duration and/or a first irradiation intensity. In various examples, a first dosage (which may be referred to as a “short pulse”) comprises an irradiation time of about 30 seconds to about 10 minutes, including all 0.1 second values and ranges therebetween and/or an intensity of from about 10 mW/cm² to about 1000 mW/cm², including all 0.1 mW/cm² values and ranges therebetween.

In various examples, an irradiating (such as, for example, a first irradiating) results in a desired polymerization (e.g., conversion percentage or the like) of one or more or all first monomer(s). In various examples, the irradiating results in about 0.1% conversion to about 100% conversion of the first monomer. In various examples, conversion percentage is observed by spectroscopy (e.g., nuclear magnetic resonance spectroscopy, such as, for example, ¹H NMR, ¹³C NMR, or the like, infrared spectroscopy, or the like), thermal analysis (e.g., differential scanning calorimetry (DSC) or the like), or the like, or any combination thereof.

In various examples, an irradiating (such as, for example, a first irradiating) results in substantially no or no polymerization of one or more or all second monomer(s). In various examples, polymerization of second monomer(s) is observed by spectroscopy (e.g., nuclear magnetic resonance spectroscopy, such as, for example, ¹H NMR, ¹³C NMR, or the like, infrared spectroscopy, or the like), thermal analysis (e.g., differential scanning calorimetry (DSC) or the like), or the like, or any combination thereof.

In various examples, a polymerization method further comprises irradiating (such as, for example, a second irradiation) the irradiated polymerization composition (e.g. resulting from the first irradiation) with a second dosage of light comprising (or that is) a second wavelength of light, where at least a portion of the second monomer(s) is polymerized, and the first wavelength and the second wavelength are substantially the same or the same. In various examples, irradiating the irradiated polymerization composition with a second dosage of light (such as, for example, a second irradiating) is carried out after a desired percent conversion of the first monomer. In various examples, irradiating the irradiated polymerization composition with a second dosage of light is carried out after a completion of the irradiating the polymerizable composition. In various examples, all first polymerization agent(s) and/or all second polymerization agent(s) absorb (or art activated by) substantially the same or the same wavelength.

In various examples, irradiating the irradiated polymerization composition with a second dosage of light is carried out after a desired percent conversion of the first monomer. In various examples, irradiating the irradiated polymerization composition with a second dosage of light is carried out after a completion of the irradiating the polymerizable composition. In various examples, the second dosage of light interacts with at least a second polymerization agent or all the second polymerization agent(s) resulting in polymerization of at least a portion or all second monomer(s). In various examples, a second dosage of light comprises a second irradiation duration and/or a second irradiation intensity. In various examples, a second dosage (which may be referred to as a “long pulse”) comprises an irradiation time of about 10 minutes (e.g., greater than about 10 minutes) to about 1 hour, including all 0.1 second values and ranges therebetween and/or an intensity of from about 10 mW/cm² to about 1000 mW/cm², including all 0.1 mW/cm² values and ranges therebetween. In various examples, a first dosage comprises an irradiation time of about 30 seconds to about 10 minutes, including all 0.1 second values and ranges therebetween and/or an intensity of from about 10 mW/cm² to about 1000 mW/cm², including all 0.1 mW/cm² values and ranges therebetween and/or a second dosage comprises an irradiation time of about 10 minutes (e.g., greater than about 10 minutes) to about 1 hour, including all 0.1 second values and ranges therebetween and/or an intensity of from about 10 mW/cm² to about 1000 mW/cm², including all 0.1 mW/cm² values and ranges therebetween.

In various examples, substantially none or none the first monomer, if present, is polymerized (e.g., polymerized by the irradiating of the irradiated polymerization composition). In various examples, polymerization of the first monomer is observed by spectroscopy (e.g., nuclear magnetic resonance spectroscopy, such as, for example, ¹H NMR, ¹³C NMR, or the like, infrared spectroscopy, or the like), thermal analysis (e.g., differential scanning calorimetry (DSC) or the like), or the like, or any combination thereof.

In various examples, irradiating (such as, for example, a second irradiating) results in a desired polymerization (e.g., conversion percentage or the like) of one or more or all second monomer(s). In various examples, the irradiating results in about 0.1% conversion to about 100% conversion of one or more or all second monomer(s). In various examples, conversion percentage is observed by spectroscopy (e.g., nuclear magnetic resonance spectroscopy, such as, for example, ¹H NMR, ¹³C NMR, or the like, infrared spectroscopy, or the like), thermal analysis (e.g., differential scanning calorimetry (DSC) or the like), or the like, or any combination thereof.

In various examples, irradiating (such as, for example, a first irradiating, a second irradiating, or both) is patterned irradiating. In various examples, irradiating (such as, for example, a first irradiating, a second irradiating, or both) is carried out in a selected pattern. In various examples, irradiating (such as, for example, a first irradiating, a second irradiating, or both) is independently photopatterning (such as, for example, photolithography or the like). In various examples, irradiating (such as, for example, a first irradiating, a second irradiating, or both) is independently carried out using a photomask, a direct-write system, or the like. In various examples, a thermoset polymer material comprising a desired shape is formed. In various examples, a thermoset polymer material comprises two or more domains, wherein at least two or more of the domains comprise one or more different structural features, one or more different physical properties (e.g., Young's modulus, stiffness, crosslink density, storage modulus, or the like), or any combination thereof

In various examples, a polymerization is run neat (e.g., the polymerizable composition does not comprise a solvent). In various examples, the polymerizable composition comprises one or more solvent(s). Non-limiting examples of solvents include chlorinated hydrocarbons (e.g., dichloromethane (DCM), dichloroethane (DCE), and the like), alkanes (e.g., hexanes, cyclohexane, and the like), ethers (diethyl ether, cyclopentyl methyl ether (CPME), and the like), aromatic hydrocarbons (toluene and the like), and the like, and any combination thereof.

In various examples, a polymerizable composition is a film, a sheet, or the like. In various examples, a polymerizable composition is bulk material, which may be confined in container, reactor, or the like.

A method (e.g., an irradiation, polymerization reaction, or the like) can be performed under various reaction conditions. A method (e.g., an irradiation, polymerization reaction, or the like) can comprise one or more step(s) and each step can be performed under the same or different reaction conditions as other steps.

A method (e.g., an irradiation, polymerization reaction, or the like) can be carried out at various temperatures. In various examples, a polymerization reaction is carried out at about room temperature (e.g., from about 20° C. to about 30° C., including all 0.1° C. values and ranges therebetween), below room temperature (e.g., below about room temperature, such as for example, from about −78° C. to about room temperature, including all 0.1° C. values and ranges therebetween), or above room temperature (e.g., above room temperature up to or about a boiling point of the solvent(s), if present) (e.g., room temperature to about 100° C. or above, or any combination thereof (e.g., where each irradiation, polymerization reaction, or the like) is performed at a different temperature as other steps). In various examples, a method (e.g., an irradiation, polymerization reaction, or the like) is carried out at about −78° C. to about 100° C., including all 0.1° C. values and ranges therebetween.

A method (e.g., an irradiation, polymerization reaction, or the like) can be carried out at various pressures. In various examples, a method (e.g., an irradiation, polymerization reaction, or the like) is carried out at atmospheric pressure (e.g., 1 standard atmosphere (atm) at sea level), at greater than atmospheric pressure (e.g. heating in a sealed pressurized reaction vessel and the like), at below atmospheric pressure (e.g., under vacuum (e.g., from about 1 mTorr or less to about 100 mTorr or less, including all 0.1 mTorr values and ranges therebetween) (e.g., about 100 mTorr or less, about 50 mTorr or less, about 10 mTorr or less, or about 1 mTorr or less) and the like), or any combination thereof (e.g., where each step is performed at a different pressure as other steps).

A method (e.g., an irradiation, polymerization reaction, or the like) can be carried out for various times. The reaction time can depend on factors such as, for example, temperature, pressure, irradiation time(s), efficiency of the photopolymerization agent(s), mixing (e.g., stirring or the like), or the like, or any combination thereof. In various examples, reaction times range from about seconds (e.g., about 10 seconds) to greater than about 24 hours, including all integer second values and ranges therebetween, or any combination thereof (e.g., where each step is performed at the same time or a different time as other steps).

In various examples, a method is carried out in air or an inert atmosphere. In various examples, a method is carried out in an inert atmosphere comprising one or more inert gas(es). Non-limiting examples of inert gases include nitrogen, argon, and the like, and any combination thereof.

In various examples, a method further comprising functionalizing a polymer product formed as a result of the irradiating of the polymerizable composition and/or irradiation of the irradiated polymerizable composition. In various examples, in the case where a polymerizable composition comprises one or more chain transfer agent(s), a polymer product comprises a terminal group or terminal groups, independently formed from a chain transfer agent and the method further comprises functionalization of the polymer by reaction of the terminal group(s).

In an aspect, the present disclosure provides articles of manufacture. In various examples, an article of manufacture comprises one or more polymerization product(s) (such as, for example, thermoset polymer material(s) or the like) of the present disclosure. In various examples, one or more or all of the polymerization product(s) (e.g., thermoset polymer material(s) or the like) is/are formed by a method of the present disclosure. In various examples, an article of manufacture comprises one or more polymerization product(s) (such as, for example, thermoset polymer materials(s) or the like) of the present disclosure, where at least a portion or all of the thermoset polymer material(s) is/are crosslinked, photocured, or the like. Non-limiting examples of articles of manufacture are described herein.

Non-limiting examples of articles of manufacture include shoes (such as, for example, an insole, or the like). Methods of making articles of manufacture using polymerization product(s) (e.g., thermoset polymer(s)) of the present disclosure are known in the art.

The following Statements provide examples of polymerization methods and compositions of the present disclosure:
Statement 1. A polymerization method comprising: irradiating a polymerizable composition comprising: one or more first monomer(s); one or more second monomer(s); one or more first polymerization agent(s) (which may be a photoinitiator/photoinitiators); and one or more second polymerization agent(s) (which may be a photoinitiator/photoinitiators), with a first dosage of light comprising a first wavelength of light, where at least a portion of the first monomer(s) is/are polymerized and substantially none or none the second monomer(s) is/are polymerized.
Statement 2. A polymerization method according to Statement 1, the method further comprising irradiating the irradiated polymerization composition with a second dosage of light comprising (or is) a second wavelength of light, where at least a portion of the second monomer(s) is polymerized, and the first wavelength and the second wavelength are substantially the same or the same.
Statement 3. A method according to Statement 1 or 2, where
i) the pH of the polymerizable composition comprises a first pH prior to and/or during the irradiating of the polymerizable composition and/or a second pH prior to and/or during the irradiating of the irradiated polymerizable composition, and the first pH is different (e.g., higher) (or substantially different) than the second pH; or
ii) the pH of the polymerizable composition comprises a first pH prior to the irradiating of the polymerizable composition, a second pH during or after irradiating of the polymerizable composition, and a third pH during or after the irradiating of the irradiated polymerizable composition, where the first pH, second pH, and third pH are all substantially different (or different).
Statement 4. A method according to any one of the preceding Statements, where the polymerization of the first monomer is a radical polymerization, a cationic polymerization, or the like.
Statement 5. A method according to any one of the preceding Statements, where the first polymerization agent(s) is/are chosen from photosensitizers, photoacid generators (which may, independently, comprise one or more coordinating anion(s)), organic salts comprising coordinating anion(s), inorganic soluble salts comprising coordinating anion(s), or the like, or any combination thereof.
Statement 6. A method according to any one of the preceding Statements, where the first monomer(s) is/are chosen from radical polymerization monomers, cationic polymerization monomers, and the like, and any combination thereof.
Statement 7. A method according to any one of the preceding Statements, where the polymerization of the second monomer(s) is a cationic polymerization, or the like.
Statement 8. A method according to any one of the preceding Statements, where the second polymerization agent(s) is/are chosen from photoacid generators (which, independently, comprise one or more non-coordinating anion(s), one or more coordinating anion(s), or any combination thereof), or the like, and any combination thereof.
Statement 9. A method according to any one of the preceding Statements, where the second monomer(s) is/are chosen from cationic polymerization monomers, and the like, and any combination thereof.
Statement 10. A method according to any one of the preceding Statements, where the polymerizable composition comprises one or more crosslinking monomer(s).
Statement 11. A method according to any one of the preceding Statements, where
i) the first monomer(s) is/are chosen from radical polymerization monomers, and the like, and any combination thereof and/or the first polymerization agent(s) is/are chosen from photosensitizers, and the like, and any combination thereof, and/or the first monomer is polymerized by a radical polymerization, and/or
the second monomer(s) is/are chosen from cationic polymerization monomers, and the like, and any combination thereof and/or the second polymerization agent comprises a photoacid generator/photoacid generators (which may comprise non-coordinating anion(s), coordinating anion(s), or any combination thereof) and/or the second monomer(s) is/are polymerized by a cationic polymerization;
ii) the where the first monomer(s) is/are chosen from cationic polymerization monomers (such as, for example, vinyl ethers and the like), and the like, and any combination thereof and/or the first polymerization agent comprises a photoacid generator/photoacid generators and coordinating anion(s) and/or organic salts/inorganic salts comprising one or more coordinating anion(s) and/or the first monomer is polymerized by a cationic polymerization, and/or
the second monomer(s) is/are chosen from cationic monomers, and the like, and any combination thereof and/or the second polymerization agent comprises a photoacid generator/photoacid generators each comprising one or more non-coordinating anion(s) and/or the second monomer(s) is/are polymerized by a cationic polymerization.
Statement 12. A method according to any one of the preceding Statements, where the method is used in or part of a 3-D printing method, an additive manufacturing method, or the like, or any combination thereof, or is used in a photocurable thermoset application, or the like, or any combination thereof.
Statement 13. A method according to any one of the preceding Statements, the method further comprising functionalizing the polymer product formed as a result of the irradiating of the polymerizable composition and/or irradiation of the irradiated polymerizable composition.
Statement 14. A polymerizable composition comprising:
   one or more first monomer(s);
   one or more second monomer(s);
   one or more first polymerization agent(s); and
   one or more second polymerization agent(s).
Statement 15. A polymerizable composition according to Statement 14, where the first monomer(s) is/are chosen from radical polymerization monomers, cationic polymerization monomers, and the like, and any combination thereof.
Statement 16. A polymerizable composition according to Statement 14 or 15, where the first polymerization agent(s) is/are chosen from photosensitizers, photoacid generators (which may, independently, comprise one or more coordinating anion(s)), organic salts comprising coordinating anion(s), inorganic soluble salts comprising coordinating anion(s), and the like, and any combination thereof.
Statement 17. A polymerizable composition according to any one of Statements 14-16, where the second monomer(s) is/are chosen from cationic polymerization monomers, and the like, and any combination thereof.
Statement 18. A polymerizable composition according to any one of Statements 14-17, where the second polymerization agent(s) is/are chosen from photoacid generators (which, independently, may comprise one or more non-coordinating anion(s)), or the like, or any combination thereof.
Statement 19. A polymerizable composition according to any one of Statements 14-18, where the polymerizable composition further comprises one or more crosslinking monomer(s) (which may be referred to in the alternative as crosslinker(s)).
Statement 20. A polymerizable composition according to any one of Statements 14-19, where the polymerizable composition further comprises one or more chain transfer agent(s).
Statement 21. A polymerizable composition according to any one of Statements 14-20, where the polymerizable composition further comprises one or more solvent(s).
Statement 22. A polymerizable composition according to any one of Statements 14-21, where the polymerizable composition is suitable for use in a 3-D printing method, an additive manufacturing method, in a photocurable thermoset application (such as, for example, as a coating or the like), or the like, or any combination thereof.

The steps of the methods described in the various examples disclosed herein are sufficient to carry out the methods of the present disclosure. Thus, in various examples, a method consists essentially of a combination of the steps of the methods disclosed herein. In various other examples, a method consists of such steps.

The following examples are presented to illustrate the present disclosure. The examples are not intended to be limiting in any manner.

### Example 1

This example describes polymerizable compositions and polymerization methods of the present disclosure, and uses thereof.

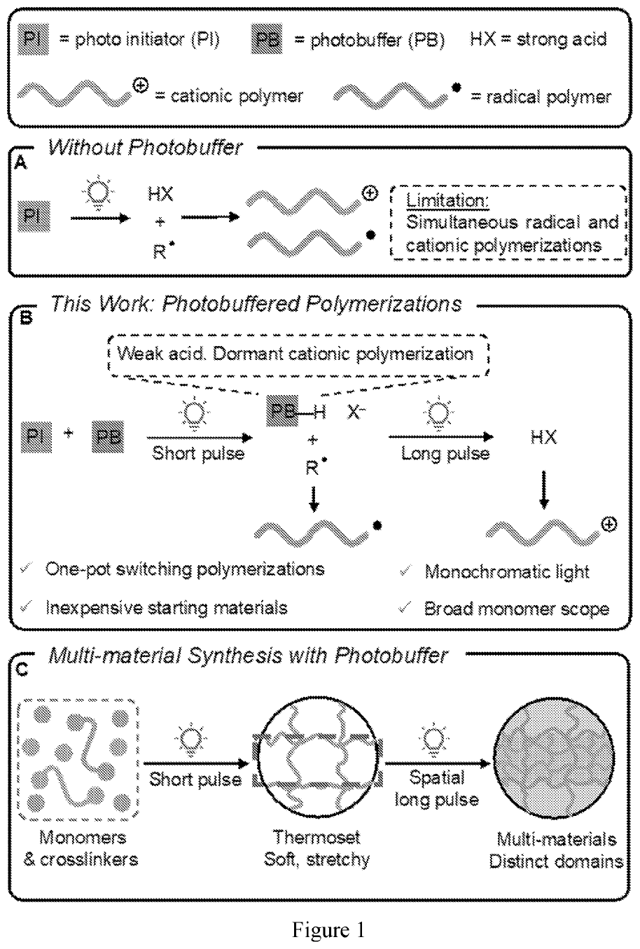

We aimed to identify a catalyst that can accelerate photoinitiated cationic polymerizations using non-fluorinated PAGs. We employed a general strategy using a weakly basic anion “photobuffer” to delay strong acid generation, enabling exclusive radical polymerization. Consequently, the two polymerizations can be divorced simply by controlling the dosage of light, a strategy we term Switching Polymerizations by Light Titration (SPLiT) (FIG. 1).

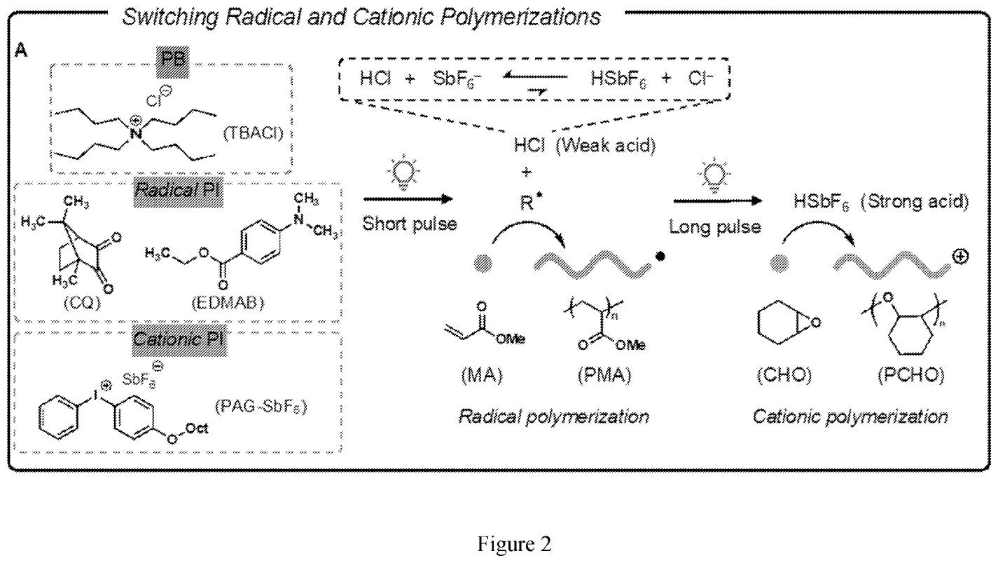

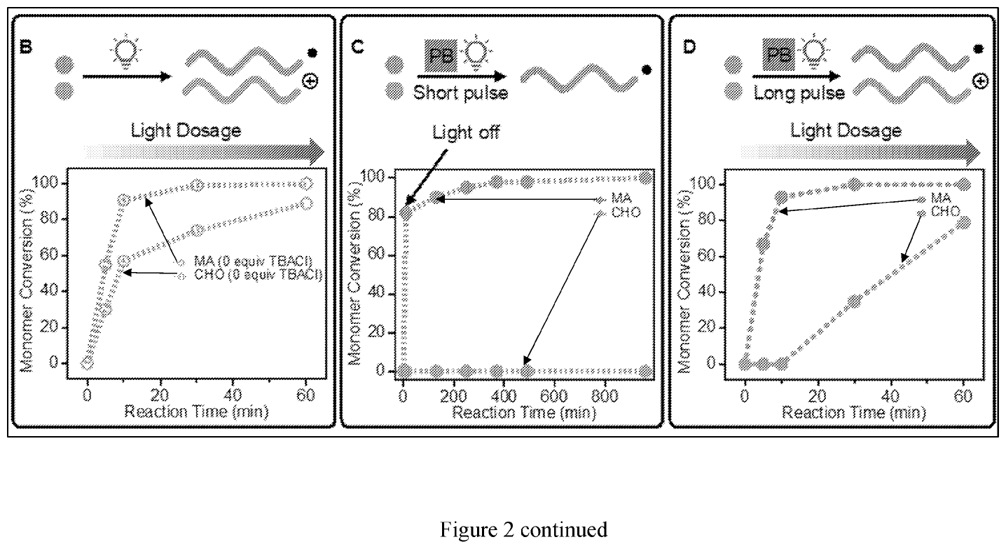

The SPLiT mechanism is shown in FIG. 2A. When excited by 456 nm light, the photosensitizer camphorquinone (CQ) is reduced by a hydrogen donor (RH), producing a ketyl radical and R., initiating radical polymerization. CQ ketyl radical is oxidized back to its ground state by the PAG-SbF₆ salt, producing H⁺ and a weakly coordinating counter anion SbF₆⁻. Under a short light pulse, any H⁺ generated combines with a stochiometric amount of a basic anion photobuffer (Cl⁻) to form a thermodynamically favorable weak acid HCl. Because HCl does not polymerize cationic monomers like epoxides, free radical polymerizations proceed exclusively while cationic polymerizations remain dormant. With further light exposure, an excess of H⁺ is generated to allow for the formation of the strong acid HSbF₆, initiating cationic polymerizations. Using this strategy, we demonstrated the in-situ synthesis of multi-materials with a monochromatic light.

Results. To demonstrate the feasibility of the SPLiT strategy, radical monomer methyl acrylate (MA) and cationic monomer cyclohexene oxide (CHO) were mixed with CQ, hydrogen donor ethyl 4-(dimethylamino) benzoate (EDMAB), photobuffer tetrabutylammonium chloride (TBACl), and PAG-SbF₆. Without the addition of the photobuffer TBACl, consumption of both monomers (86% MA and 53% CHO) was observed after 10 min blue light-emitting diode (LED) irradiation, as based on proton nuclear magnetic resonance (¹H-NMR) spectroscopy (FIG. 2B), indicating simultaneous uncontrolled radical and cationic polymerizations. In contrast, upon the addition of 1 equiv of TBACl, exclusive MA radical polymerization was observed after 10 min light dosage (67% MA conversion). No epoxide polymerization was observed (0% CHO conversion), while MA was fully converted in 960 min following the initial irradiation (FIG. 2C). Increasing the light irradiation to 60 min resulted in both radical and cationic polymerizations (100% MA and 79% CHO consumption) (FIG. 2D). These polymerization results suggested that the addition of photobuffer enables a delay in cationic initiation by buffering the super acid generation, thus facilitating the selective incorporation of acrylate and epoxide monomers by varying only the light dosage.

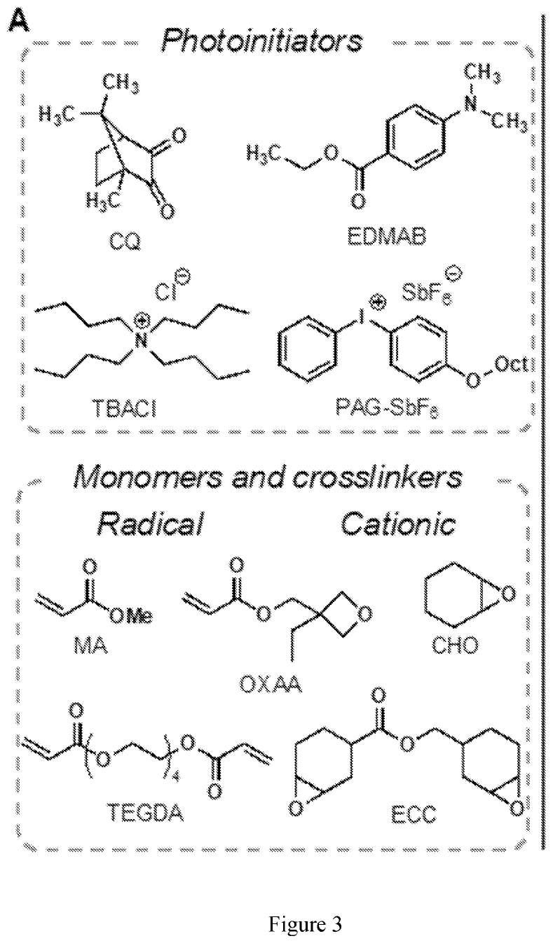

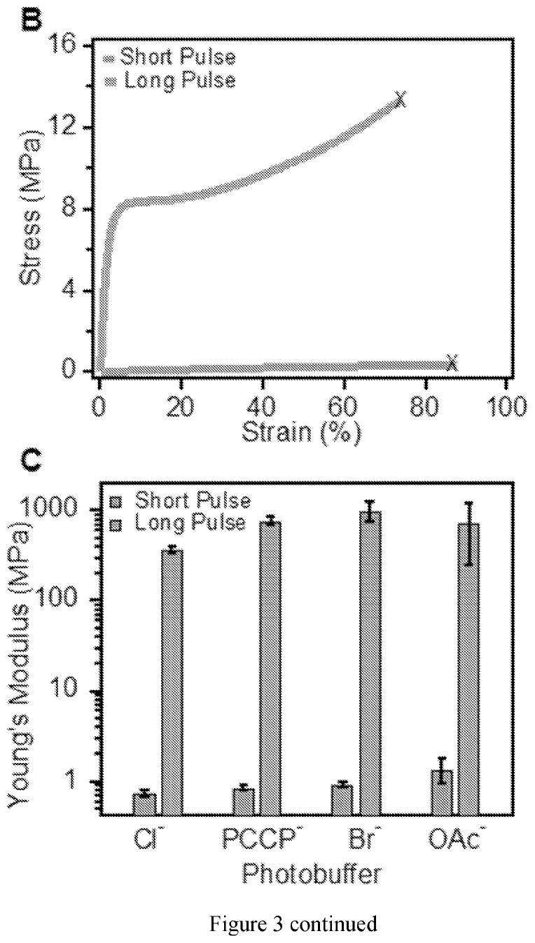

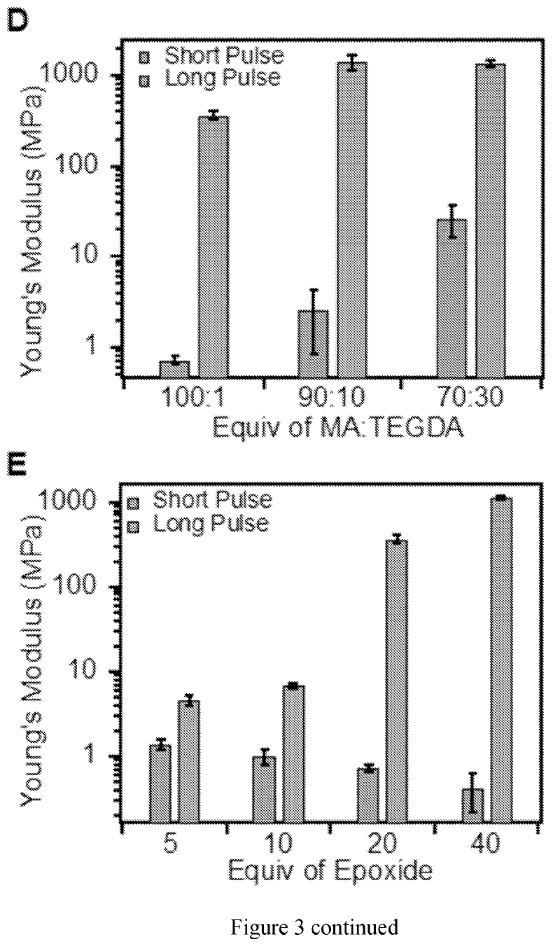

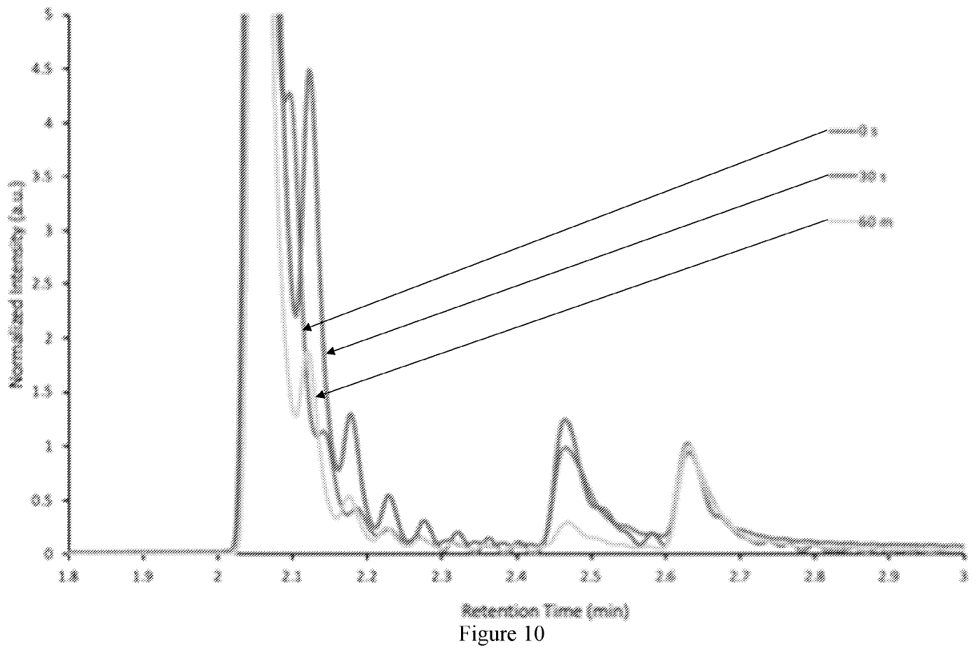

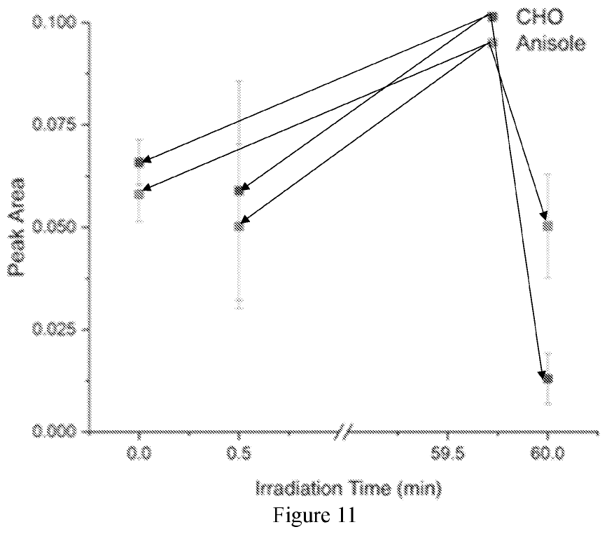

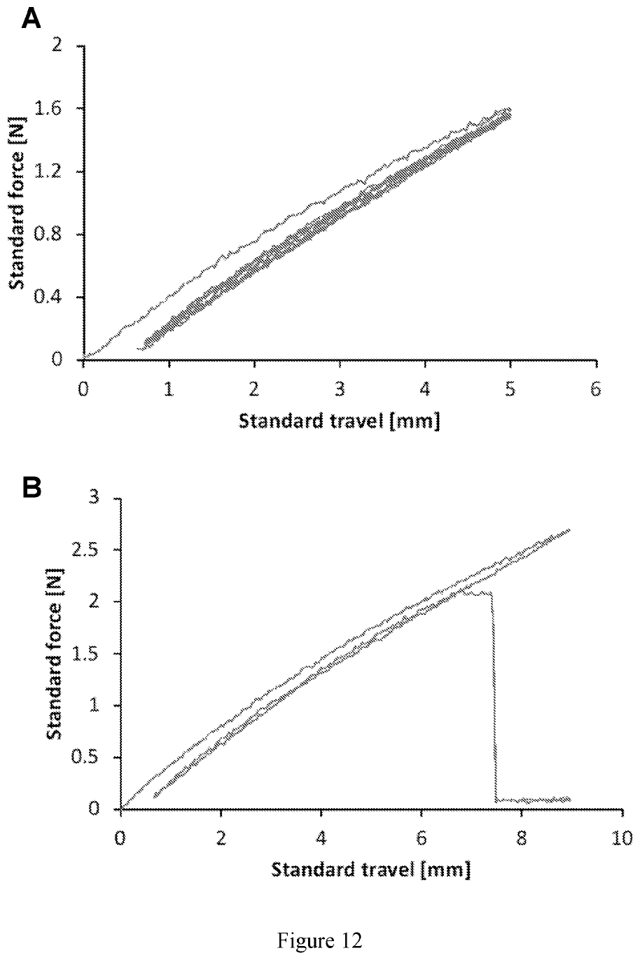

This photoswitching methodology was then applied to multi-material thermoset synthesis. Acrylate-epoxide resins were prepared by including crosslinkers in the established system (FIG. 3A). Poly(methyl acrylate) (PMA) exhibits a low glass transition temperature (T_{g}) of ˜10° C., yielding a soft and stretchy crosslinked material. Incorporation of the higher T_{g} poly(cyclohexene oxide) (PCHO) (T_{g}˜70° C.) affords a hard and stiff thermoset. To measure the acrylate-epoxide multi-material mechanical properties, uniaxial tensile tests were performed. A crosslinked film with Young's modulus (E) of 0.7 MPa was formed upon 30 s (s=second(s)) blue light (FIG. 3B). Successive 1 h light irradiation increased the E to 367 MPa, indicating the incorporation of epoxides into the films, as supported by gas chromatography (GC) experiments (FIG. 10). Thus, the SPLiT strategy can be employed to construct materials with different physical properties from bulk photobuffered resin simply by varying irradiation time.

To investigate the scope of the photobuffer, a variety of coordinating anions were examined in the production of the acrylate-epoxide resins. Tetrabutylammonium bromide (Br), PCCP-(pentacarbomethoxycyclopentadiene anion), and acetate (OAc) salts all afforded elastic crosslinked films with E of 0.91 MPa, 0.85 MPa, and 1.36 MPa respectively after 30 s light irradiation. 1-hour light irradiation drastically increased the E to 998 MPa, 767 MPa, and 732 MPa (FIG. 3C). These results demonstrate the breadth of photobuffer anions that can be employed for SPLiT.

The mechanical properties of the acrylate-epoxide multi-materials can be systematically tuned by altering the ratio of monomers to crosslinkers. Altering the ratio of MA:TEGDA from 100:1 to 70:30 increased E from 0.73 MPa to 26.63 MPa with 30 s light irradiation (FIG. 3D), demonstrating the tunability of PMA crosslink density under short light pulse. With a constant ratio of MA:TEGDA, increasing the epoxide equivalents from 5 to 40 under 1 h light changed the E from 4.6 MPa to 367 MPa (FIG. 3E). Notably, no significant change in the film stiffness was observed with altered epoxide equivalents under 30 s light exposure, indicating independent tunability of acrylate-epoxide thermoset properties both under short and long light pulses.

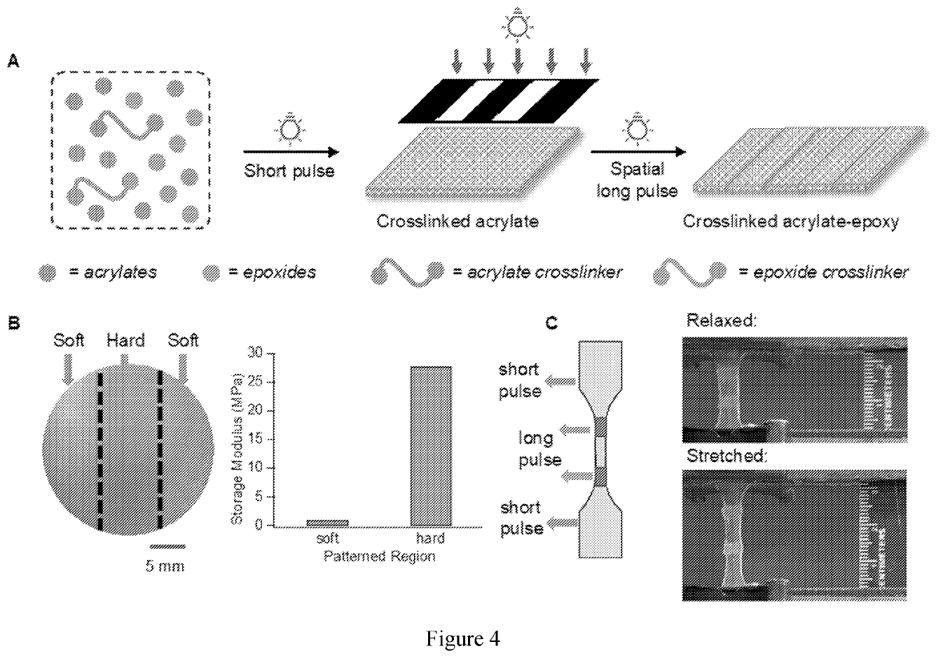

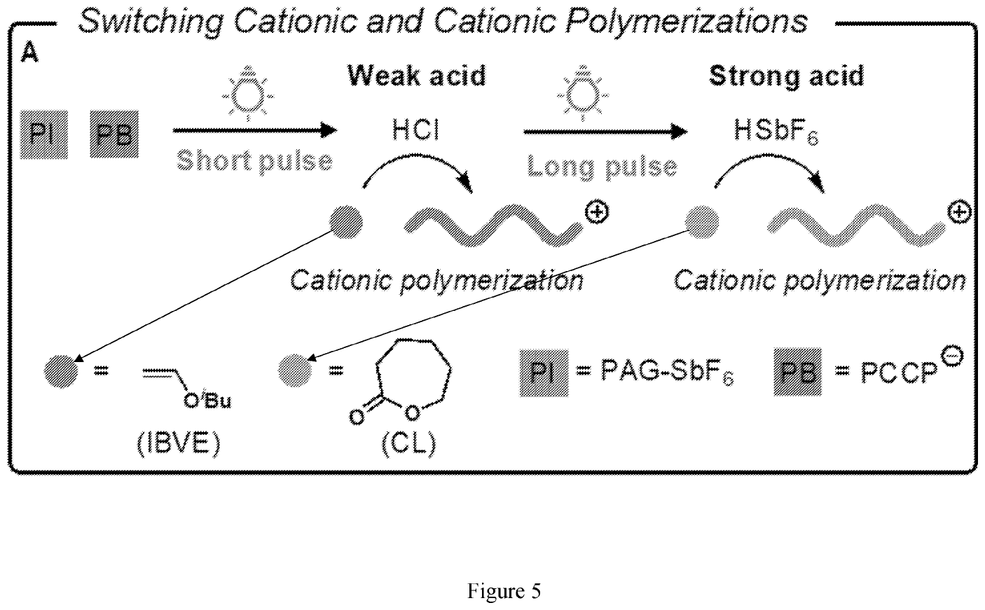

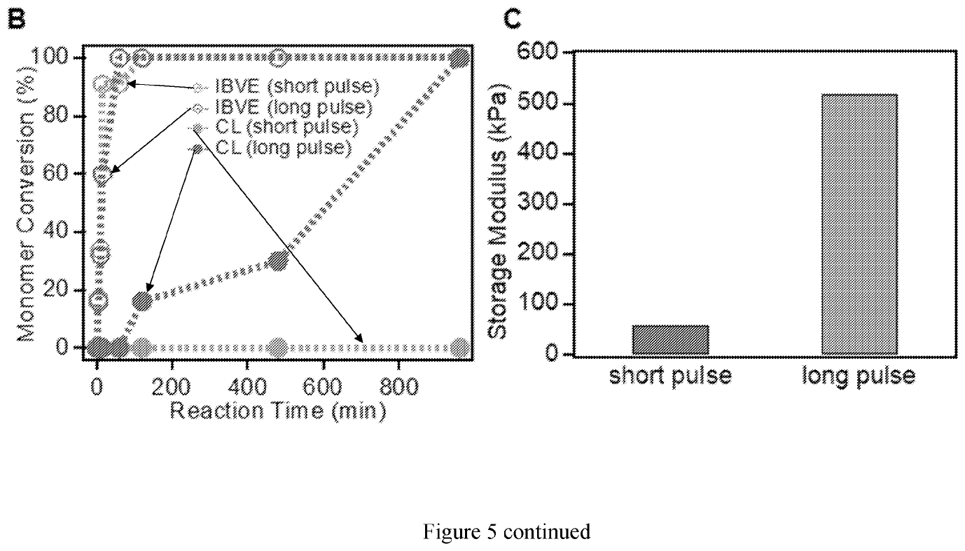

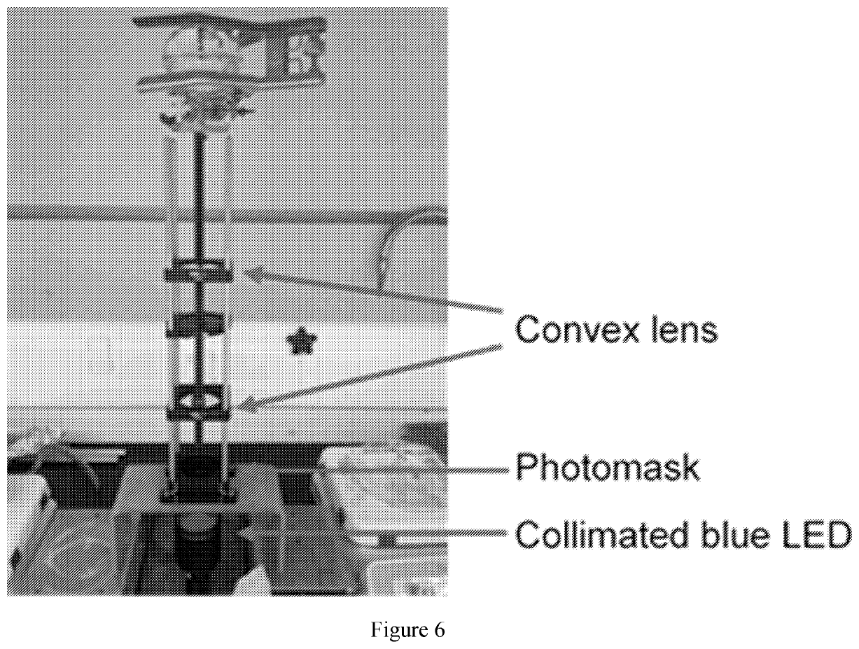

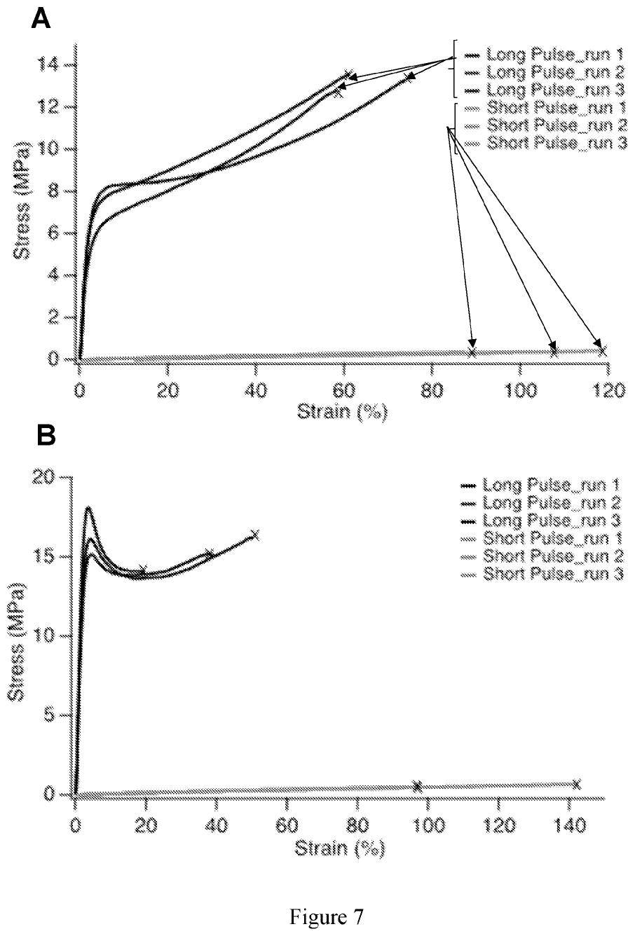

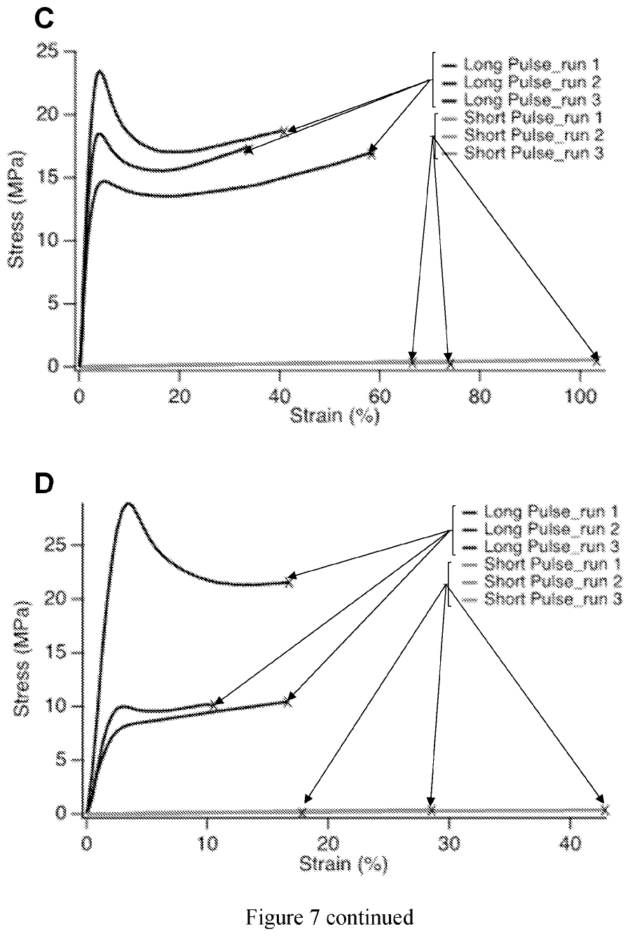

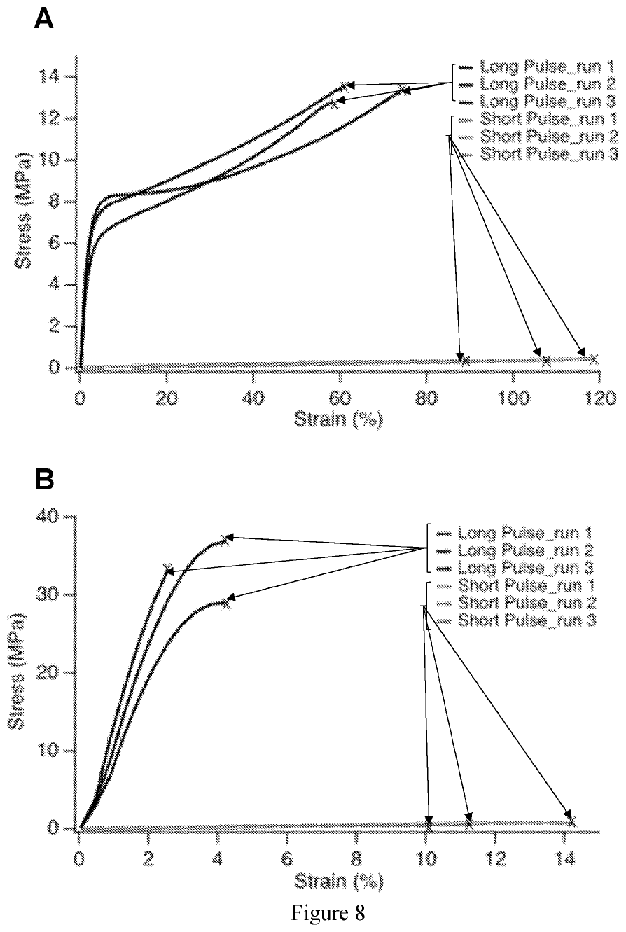

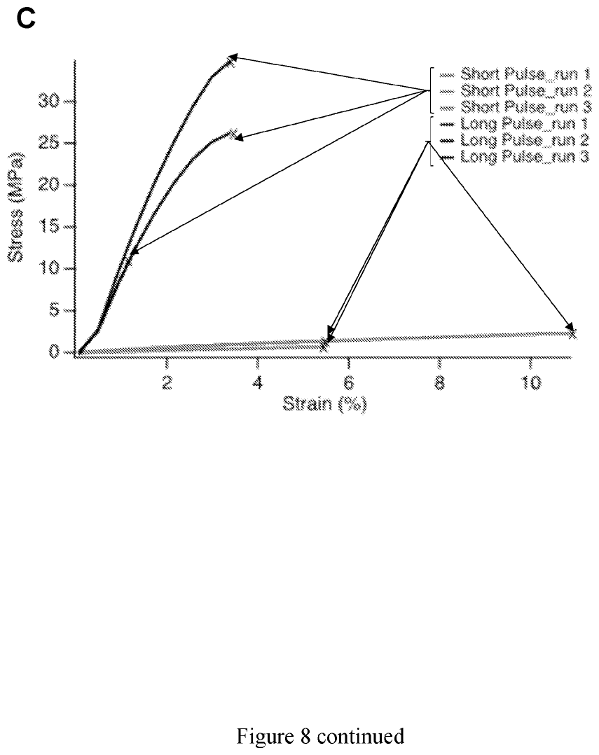

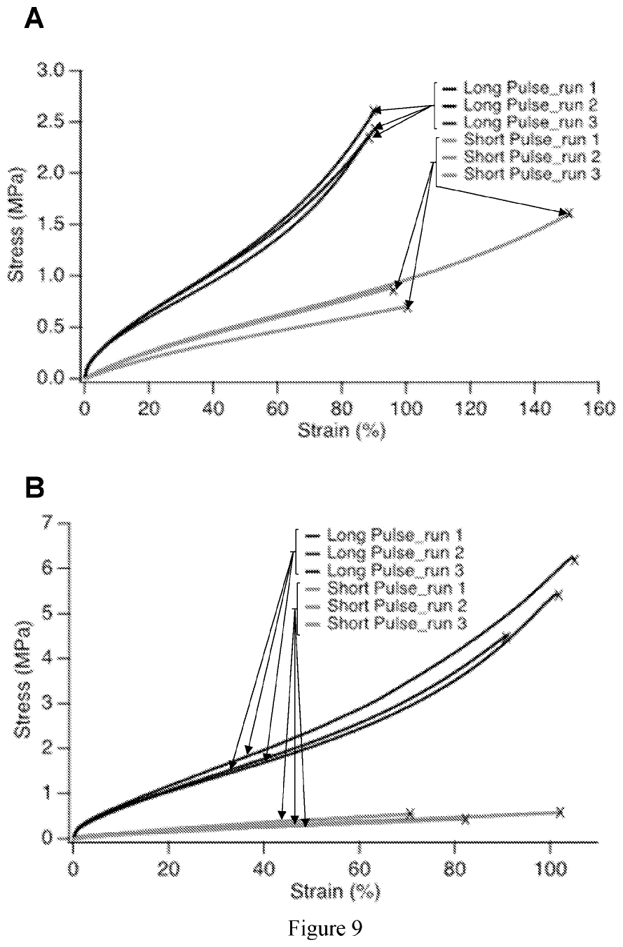

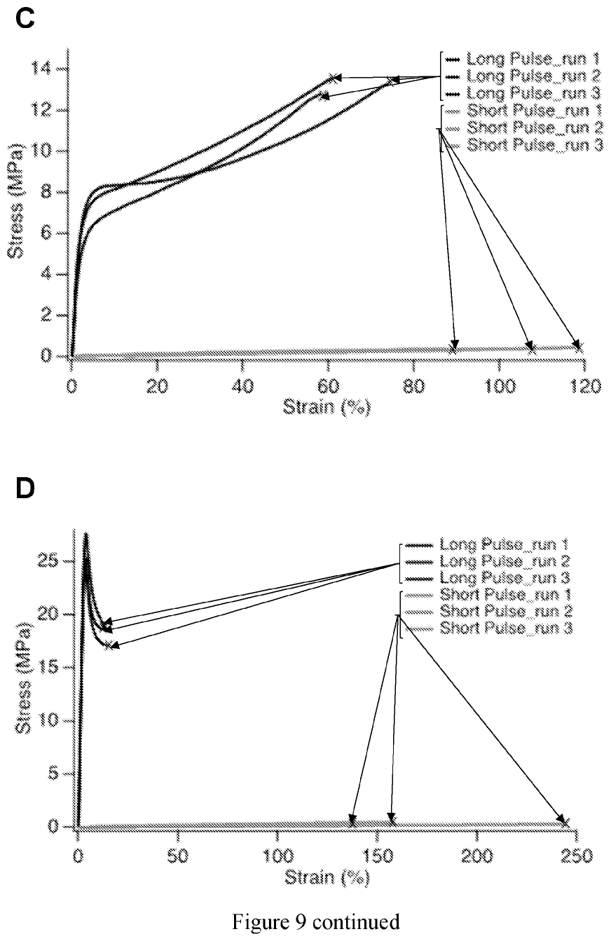

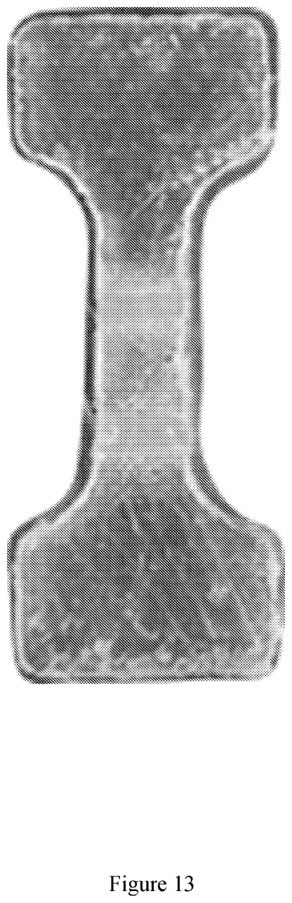

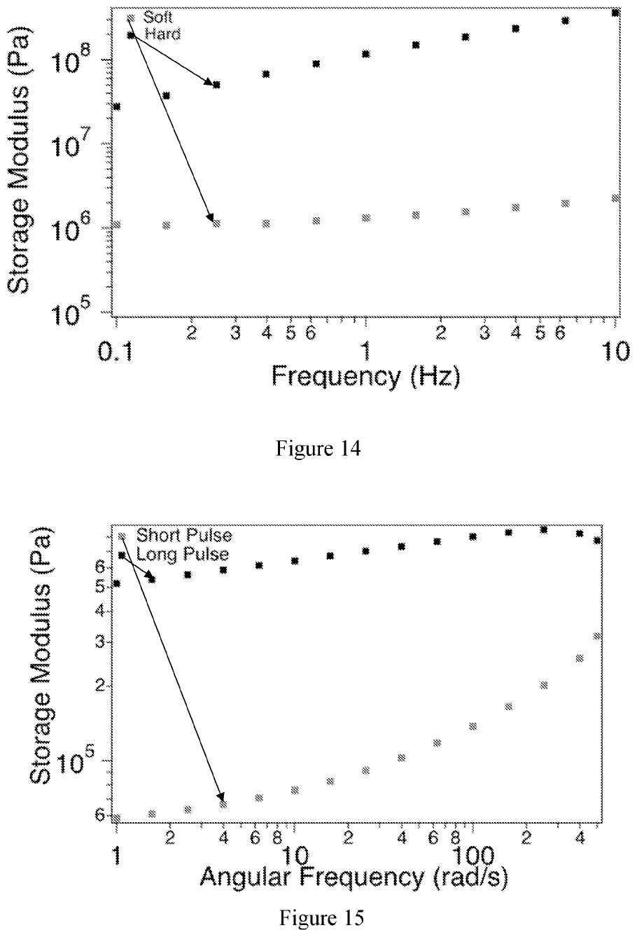

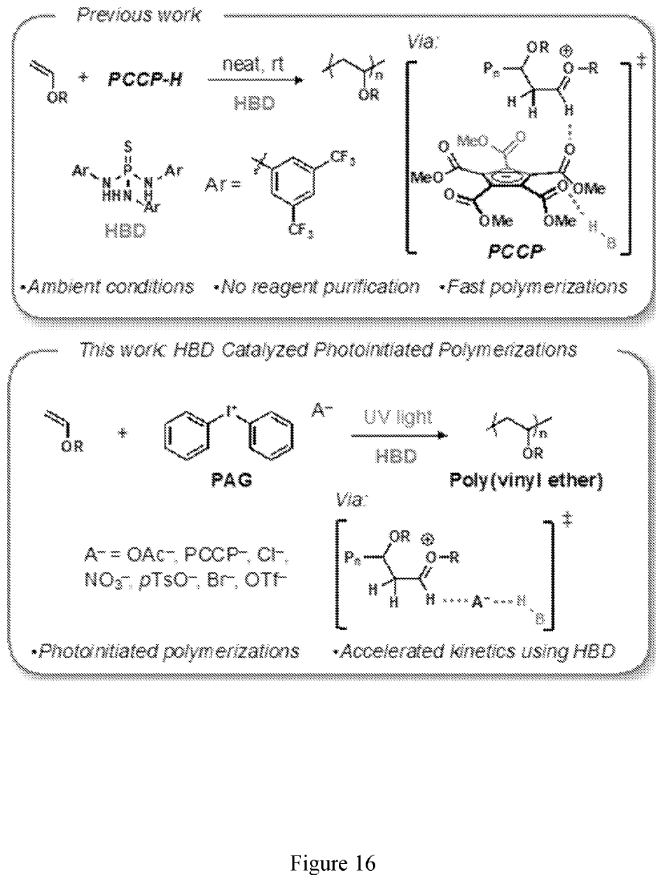

Spatial control of multi-material properties was investigated by applying photomasks (FIG. 4A). Irradiating an acrylate-epoxide resin with 10 s blue light created a soft crosslinked film with a storage modulus (G′) of 1.09 MPa at 0.1 Hz frequency using dynamic mechanical analysis (DMA) (FIG. 4B). Subjecting the mid-section of the film to blue light for another hour yielded a domain with increased G′ of 27.7 MPa. This change in magnitude confirms that the photobuffered resin enables bulk synthesis of multi-materials using a single wavelength of light. The feature size of spatial control was scaled down to 1 mm with distinguishable boundaries between two crosslinked domains (FIG. 13). Cyclic tensile testing was performed on a photopatterned dogbone sample with alternating soft and hard regions (FIG. 4C). The soft domains elongated while the hard domains maintained the same length. A Young's modulus of 1.12 MPa was calculated based on the stress-strain curve, equivalent to the Young's modulus of the soft domain. These results demonstrate the capability of SPLiT to make spatially distinct multi-materials.

The generality of SPLiT was examined on other classes of radical and cationic monomers. Methyl methacrylate (MMA) was mixed with CHO. With photobuffer TBACl, 1-hour light irradiation polymerized only MMA, while two hours light irradiation polymerized both MMA and CHO. Cationic monomers caprolactone (CL) and 1,3-dioxolane (DXL) were also studied in combination with radical monomer MA. Rapid MA polymerizations were observed in both the MA-CL and MA-DXL systems under short light pulse, while no cationic ring opening polymerization was detected in either (SI). Extending the light exposure time, the cationic polymerizations ran to high conversions. (46% CL and 84% DXL). As supported by these studies, the use of photobuffer to delay the strong acid generation in SPLiT is applicable to a wide monomer scope.

We also hypothesized that SPLiT can thermodynamically resolve the polymerization of two cationic monomers in one pot. We hypothesized that the weak acid generated by the photobuffer under a short light pulse could first polymerize certain cationic monomers such as vinyl ethers, while a second orthogonal cationic polymerization could be initiated via a strong acid generation upon longer irradiation. To test this hypothesis, we created a resin of two cationic monomers isobutyl vinyl ether (IBVE) and CL, along with PAG-SbF₆ and photobuffer TBACl. Subjecting the solution to 300 nm light for 1 hour polymerized 68% IBVE and 0% CL. 960 min UV light led to 100% conversions for both cationic monomers (FIG. 4C), supporting the theory that the weak acid generation buffers the second cationic polymerization. We then pursued synthesis of multi-materials with two cationic components. Irradiating an IBVE-CL resin for 60 min afforded a soft crosslinked vinyl ether film with a storage modulus of 59 kPa at an angular frequency of 1 rad/s, measured using parallel plate oscillatory rheology. 960 min light irradiation increased the film storage modulus to 518 kPa (FIG. 4D), indicating that the incorporation of the caprolactones hardened the thermoset due to the crystallinity of poly(CL). The SPLiT strategy, therefore, can switch not only between polymerization types (i.e., radical and cationic), but also between monomers of the same polymerization class in one pot.

In conclusion, we developed a methodology that can switch polymerization mechanisms in one pot by tuning only the dosage of a single wavelength light. We applied this method to make multi-material thermosets. The physical properties of the materials can be systematically tuned both under short and long light irradiations. By using photomasks, we created spatially different crosslinked domains with tunable mechanical properties. This methodology should enable 3D printing multi-materials with monochromatic light.

General Reagent Information. All thermoset synthesis were set up a Unilab MBraun glovebox with a nitrogen atmosphere and irradiated with blue LED (455 nm, 0.14 mW/cm²), blue Kessil lamp (PR160L 456 nm, 23 mW/cm² at reaction surface), or blue Thorlabs collimated LED (455 nm, 500 mW, 86 mW/cm² at reaction surface) under a nitrogen atmosphere outside the glovebox. Monomers methyl acrylate (MA, 99%, Sigma Aldrich, contains ≤100 ppm monomethyl ether hydroquinone as inhibitor), methyl methacrylate (MMA, 99%, Sigma Aldrich, contains ≤30 ppm monomethyl ether hydroquinone as inhibitor), cyclohexene oxide (CHO, 98%, Sigma Aldrich), ε-caprolactone (CL, 99%, Oakwood Chemical), and isobutyl vinyl ether (IBVE, 99%, TCI) were dried over calcium hydride (CaH₂, ACROS organics, 93% extra pure, 0-2 mm grain size) overnight, distilled under nitrogen followed by 3 freeze-pump thaw cycles and then 5 stored in the glove box freezer (−35° C.). Tetra (ethylene glycol) diacrylate (TEGDA, >90.0% stabilized with MEHQ, TCI), 3,4-epoxycyclohexylmethyl 3,4-epoxycyclohexanecarboxylate (ECC, Sigma Aldrich), (±)-Camphorquinone (CQ, 98%, TCI), ethyl 4-(dimethylamino)benzoate (EDMAB, 99%, Sigma Aldrich), tetrabutylammonium chloride (TBACl, Sigma Aldrich), [4-octyloxy]phenyl]phenyliodonium hexafluoroantimonate (PAG-ISbF6, 95%, AstaTech) were dried under vacuum and used in glovebox. Triethylamine (TEA, EMD Millipore), acryloyl chloride (≥97%, Lancaster Synthesis), methanol (MeOH, Fischer Chemical), and silver acetate (AgOAc, Millipore Sigma) were used as received. Dichloromethane (DCM) was purchased from J.T. Baker and purified by vigorous purging with argon for 2 h, followed by passing through two packed columns of neutral alumina under argon gas on the JC Meyer solvent system. Silicone molds were purchased on Sophie & Toffee and used as received. (3-ethyloxetan-3-yl)methyl acrylate (OXAA) and bis-(E-caprolactone-4-yl) (BCY) were synthesized according to literature procedures. 1,2,3,4,5-Pentacarbomethoxycyclopentadiene (PCCPH) and tris(3,5-bis(trifluoromethyl)phenyl) thiophosphotriamide (HBD) were synthesized according to a reported literature procedure.

General Analytical Information. Nuclear magnetic resonance (NMR) spectra were recorded on a Bruker 500 MHz instrument. Uniaxial tensile testing studies were performed using a Shimadzu Autograph AGS-X tensile tester with pneumatic grips and 500 N load cell. ASTM D-1708 standard dogbone-shaped samples (ca. 1.0 mm (T)×5.0 mm (W)×20 mm (L) with gauge lengths measured from grip to grip) were elongated at 22 mm/min until break. Data analysis was performed using TrapeziumX v. 1.5.1 software. Young's modulus (E) was calculated using the slope of linear elastic region at low strain.

Cyclic Tensile Testing. Cyclic testing was performed on a Zwick/Roell Z010 testing system equipped with screw grips. A cyclic loading of 25% strain at 25 mm/min was applied for 5 cycles. Curves smoothed in Igor Pro 9.

GC-FID chromatograms were recorded on a Shimadzu GC-2010 equipped with an Equity-1701 column (0.25 μm film thickness, 0.25 mm I.D., 3 m length). The temperature was programmed as follows: injection at 150° C., oven ramping from 140 to 150° C. at a rate of 2° C./min, and FID at 200° C. Helium was used as a carrier gas at a flow rate of 50 mL/min. Chromatographic data were processed using OriginPro software and normalized to the internal standard.

DMA tests were performed on a TA Instruments DHR-20 rheometer using a rectangle 0.05 N. Strain sweeps (0.01-100%) at 25° C. were first performed at 1 Hz to determine the linear viscoelastic region. A 1% strain was selected as it lied within the linear viscoelastic region. Storage modulus (G′) profiles were obtained at 25° C. and 1% strain with frequency oscillation from 0.1 to 10 Hz. Each sample was tested three times.

Rheological tests were performed on a TA Instruments DHR-20 rheometer using an 8 mm parallel plate. The sample was loaded onto the bottom parallel plate and the top plate was lowered to achieve an axial force of 1.0 N. Strain sweeps (0.01-100%) at 25° C. were first performed at 1 rad/s to determine the linear viscoelastic region. A 1% strain was selected as it lied within the linear viscoelastic region. Storage modulus (G′) profiles were obtained at 25° C. and 1% strain with oscillatory shear from 1 to 500 rad/s. Each sample was tested three times. 10127J Procedures for Switching MA-CHO Polymerizations with no Photobuffer. In a one-dram vial, CQ (1.65 mg, 0.01 mmol, 1 equiv), EDMAB (1.93 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and CHO (0.1 ml, 1 mmol, 100 equiv) were added to the dram vial under N₂ atmosphere and moved to blue LED strips (450 nm). Aliquots for ¹H NMR analysis were taken at 5 min, 10 min, 30 min, and 60 min light irradiation.

Procedures for Switching MA-CHO Polymerizations with Photobuffer TBACl. Short pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and CHO (0.1 ml, 1 mmol, 100 equiv) were added to the dram vial under N₂ atmosphere and moved to blue LED strips (450 nm) for 10 min and then kept in dark. Aliquots for ¹H NMR analysis were taken at 2 h, 4 h, 6 h, 8 h and 16 h while in dark. Long pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and CHO (0.1 ml, 1 mmol, 100 equiv) were added to the dram vial under N₂ atmosphere and moved to blue LED strips (450 nm). Aliquots for ¹H NMR analysis were taken at 5 min, 10 min, 30 min, and 60 min irradiation.

Procedures for Switching MMA-CHO Polymerizations with no Photobuffer. In a one-dram vial, CQ (1.65 mg, 0.01 mmol, 1 equiv), EDMAB (1.93 mg, 0.01 mmol, 1 equiv), and PAG-ISbF₆ (12.9 mg, 0.02 mmol, 2 equiv) were added and dried on vacuum. Then MMA (0.1 ml, 1 mmol, 100 equiv) and CHO (0.1 ml, 1 mmol, 100 equiv) were added to the dram vial under N₂ atmosphere and moved to blue LED strips (450 nm). Aliquots for ¹H NMR analysis were taken at 5 min, 10 min, and 30 min light irradiation.

Procedures for Switching MMA-CHO Polymerizations with Photobuffer TBACl. Short pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MMA (0.1 ml, 1 mmol, 100 equiv) and CHO (0.1 ml, 1 mmol, 100 equiv) were added to the dram vial under N₂ atmosphere and moved to blue LED strips (450 nm) for 60 min and then kept in dark. Aliquots for ¹H NMR analysis were taken at 2 h, 4 h, 8 h and 16 h while in dark. Long pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MMA (0.1 ml, 1 mmol, 100 equiv) and CHO (0.1 ml, 1 mmol, 100 equiv) were added to the dram vial under N₂ atmosphere and moved to blue LED strips (450 nm). Aliquots for ¹H NMR analysis were taken at 5 min, 10 min, 30 min, and 60 min light irradiation.

Procedures for Switching MA-CL Polymerizations with no Photobuffer. In a one-dram vial, CQ (1.65 mg, 0.01 mmol, 1 equiv), EDMAB (1.93 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and CL (0.11 ml, 1 mmol, 100 equiv) were added to the dram vial under N₂ atmosphere and moved to blue LED strips (450 nm). Aliquots for ¹H NMR analysis were taken at 5 min, 10 min, 30 min, 60 min, 2 h, 4 h, and 8 h light irradiation.

Procedures for Switching MA-CL Polymerizations with Photobuffer TBACl. Short pulse. In a one-dram vial, CQ (1.65 mg, 0.01 mmol, 1 equiv), EDMAB (1.93 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and CL (0.11 ml, 1 mmol, 100 equiv) were added to the dram vial under N₂ atmosphere and moved to blue LED strips (450 nm) for 5 min and then kept in dark. Aliquots for ¹H NMR analysis were taken at 10 min, 30 min, 1 h, 2 h, 4 h, 8 h, and 16 h while in dark. Long pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and CL (0.1 ml, 1 mmol, 100 equiv) were added to the dram vial under N₂ atmosphere and moved to blue LED strips (450 nm). Aliquots for ¹H NMR analysis were taken at 5 min, 10 min, 30 min, 1 h, 6 h, 8 h, and 16 h light irradiation.

Procedures for Switching MA-DXL Polymerizations with no Photobuffer. In a one-dram vial, CQ (1.65 mg, 0.01 mmol, 1 equiv), EDMAB (1.93 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and DXL (0.07 ml, 1 mmol, 100 equiv) were added to the dram vial under N₂ atmosphere and moved to blue LED strips (450 nm). Aliquots for ¹H NMR analysis were taken at 5 min, 10 min, 30 min, 1 h, 2 h, 4 h, and 8 h light irradiation.

Procedures for Switching MA-DXL Polymerizations with Photobuffer TBACl. Short pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and DXL (0.07 ml, 1 mmol, 100 equiv) were added to the dram vial under N₂ atmosphere and moved to blue LED strips (450 nm) for 10 min and then kept in dark. Aliquots for ¹H NMR analysis were taken at 30 min, 1 h, 2 h, 8 h and 16 h while in dark. Long pulse. In a one-dram vial, CQ (1.65 mg, 0.01 mmol, 1 equiv), EDMAB (1.93 mg, 0.01 mmol, 1 equiv), TBACl (2.78 mg, 0.01 mmol, 1 equiv), and PAG-ISbF₆ (12.9 mg, 0.02 mmol, 2 equiv) were added and dried on vacuum. Then MA (0.1 ml, 1 mmol, 100 equiv) and DXL (0.07 ml, 1 mmol, 100 equiv) were added to the dram vial under N₂ atmosphere and moved to blue LED strips (450 nm). Aliquots for ¹H NMR analysis were taken at 5 min, 10 min, 30 min, 1 h, 2 h, 4 h, 8 h, and 16 h light irradiation.

General Procedure for Making Acrylate-Epoxide Thermoset with Short Light Pulse. In a nitrogen filled glovebox, a silicone mold was charged with CQ (23.2 mg, 0.14 mmol, 1 equiv), EDMAB (27 mg, 0.14 mmol, 1 equiv), TBACl (19.5 mg, 0.07 mmol, 0.5 equiv), PAG-ISbF₆ (90.4 mg, 0.14 mmol, 1 equiv), MA (2.02 ml, 22.4 mmol, 160 equiv), TEGDA (0.06 ml, 0.224 mmol, 1.6 equiv), CHO (0.26 ml, 2.8 mmol, 20 equiv), ECC (0.62 ml, 2.8 mmol, 20 equiv), and OXAA (0.2 ml, 0.98 mmol, 7 equiv). The reaction solution was mixed until homogenous and capped with a Petri dish before removed from glovebox. Then the reaction mixture was irradiated with a blue Kessil lamp (456 nm, 25% light intensity) while cooling by blowing compressed air. After irradiation with 30 s, the reaction was opened to air. The crosslinked films were swelled in 1:1 isopropanol: acetone for overnight and dried in vacuum oven at 50° C. for overnight to remove any residue.

General Procedure for Making Acrylate-Epoxide Thermoset with Long Light Pulse. In a nitrogen filled glovebox, a silicone mold was charged with CQ (23.2 mg, 0.14 mmol, 1 equiv), EDMAB (27 mg, 0.14 mmol, 1 equiv), TBACl (19.5 mg, 0.07 mmol, 0.5 equiv), PAG-ISbF₆ (90.4 mg, 0.14 mmol, 1 equiv), MA (2.02 ml, 22.4 mmol, 160 equiv), TEGDA (0.06 ml, 0.224 mmol, 1.6 equiv), CHO (0.26 ml, 2.8 mmol, 20 equiv), ECC (0.62 ml, 2.8 mmol, 20 equiv), and OXAA (0.2 ml, 0.98 mmol, 7 equiv). The reaction solution was mixed until homogenous and capped with a Petri dish before removed from glovebox. Then the reaction mixture was irradiated with a blue Kessil lamp (456 nm, 25% light intensity) while cooling by blowing compressed air. After irradiation with 1 hour, the reaction was opened to air. The crosslinked films were dried in air for overnight before mechanical testing.

General Procedure for Spatial Control of Thermoset Properties. In a nitrogen filled glovebox, an oven-dried reaction vessel was charged with CQ (25.7 mg, 0.16 mmol, 1 equiv), EDMAB (30 mg, 0.16 mmol, 1 equiv), TBACl (21.6 mg, 0.08 mmol, 0.5 equiv), PAG-ISbF₆ (100.4 mg, 0.16 mmol, 1 equiv), MA (2.24 ml, 25.6 mmol, 160 equiv), TEGDA (0.067 ml, 0.256 mmol, 1.6 equiv), CHO (0.3 ml, 3.2 mmol, 20 equiv), ECC (0.68 ml, 3.2 mmol, 20 equiv), and OXAA (0.22 ml, 1.12 mmol, 7 equiv). The vessel was sealed with a clamp under a nitrogen atmosphere and removed from glovebox, then irradiated with a blue Kessil lamp (456 nm, 25% light intensity) while cooling by blowing compressed air. After 10 s, the vessel was moved to a blue Thorlabs collimated LED (455 nm, 500 mW, 9.1 mW/cm²) equipped with two convex lens and a photomask to focus light to a pattern on the polymer film. After 1 hour irradiation, the vessel was opened to air. The crosslinked films were dried in air for overnight before mechanical testing.

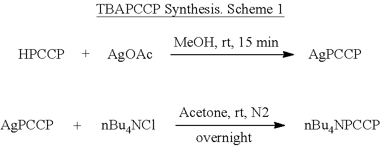

AgPCCP synthesis: a 250 ml round bottom flask was charged with AgOAc (0.338 g, 2.02 mmol) and 20 ml anhydrous MeOH. PCCPH (0.722 g, 2.02 mmol) was dissolved in 44 ml of MeOH and added to the AgOAc solution. The reaction was stirred for 15 min before filtering out the solid impurity. The resulted solution was concentrated down and dry on high vac overnight wrapped in aluminum foil to avoid light. AgPCCP NMR: ¹H NMR (500 MHz, MeOH −d4): δ 3.72 (s, 15H).

TBAPCCP synthesis: a round bottom flask was dried and charged with AgPCCP (160 mg, 0.35 mmol) and 2.5 ml anhydrous acetone. TBACl (102 mg, 0.3675 mmol) was added to AgPCCP solution and stirred overnight. The reaction was filtered and concentrated to get TBAPCCP. TBAPCCP NMR: ¹H NMR (500 MHz, Methylene Chloride-d2): 5 3.67 (s, 15H), 2.93-2.81 (m, 8H), 1.47 (p, J=8.1 Hz, 8H), 1.34 (h, J=7.3 Hz, 8H), 0.97 (t, J=7.3 Hz, 12H).

General Procedure for Switching IBVE-CL Polymerizations with no Photobuffer. In a quartz tube, TBACl (5.56 mg, 0.02 mmol, 2 equiv), and PAG-ISbF₆ (6.45 mg, 0.01 mmol, 1 equiv) were added and dried on vacuum. Then IBVE (0.13 ml, 1 mmol, 100 equiv) and CL (0.11 ml, 1 mmol, 100 equiv) were added to the dram vial under N₂ atmosphere and moved to 300 nm light. Aliquots for ¹H NMR analysis were taken at 5 min, 10 min, 15 min, 1 h, 2 h, 4 h, and 16 h light irradiation.

General Procedure for Switching IBVE-CL Polymerizations with Photobuffer TBACl. Short pulse. In a quartz tube, PAG-PCCP (6.5 mg, 0.01 mmol, I equiv), HBD (7.5 mg, 0.01 mmol, 1 equiv), and PAG-ISbF6 (12.9 mg, 0.02 mmol, 2 equiv) were added and dried on vacuum. Then IBVE (0.26 ml, 2 mmol, 200 equiv) and CL (0.22 ml, 2 mmol, 200 equiv) were added to the quartz tube under N₂ atmosphere and moved to 300 nm light for 15 min. Aliquots for ¹H NMR analysis were taken at 1 h (h=hour(s)), 2 h, 4 h, 8 h, and 16 h while in dark.

Long pulse. In a quartz tube, PAG-PCCP (6.5 mg, 0.01 mmol, 1 equiv), HBD (7.5 mg, 0.01 mmol, 1 equiv), and PAG-ISbF6 (12.9 mg, 0.02 mmol, 2 equiv) were added and dried on vacuum. Then IBVE (0.26 ml, 2 mmol, 200 equiv) and CL (0.22 ml, 2 mmol, 200 equiv) were added to the quartz tube under N₂ atmosphere and moved to 300 nm light. Aliquots for ¹H NMR analysis were taken at 5 min, 10 min, 15 min, 1 h, 2 h, 4 h, 8 h, and 16 h light irradiation.

General Procedure for Making Vinyl Ether-Lactone Thermoset. In a quartz tube, PAG-PCCP (3.25 mg, 0.005 mmol, 0.5 equiv), HBD (3.65 mg, 0.005 mmol, 0.5 equiv), BCY (11.3 mg, 0.05 mmol, 5 equiv), and PAG-ISbF₆ (6.45 mg, 0.01 mmol, 1 equiv) were added and dried on vacuum. Then IBVE (0.13 ml, 1 mmol, 100 equiv), BDVE (0.01 ml, 0.08 mmol, 9 equiv), and CL (0.11 ml, 1 mmol, 100 equiv) were added to the quartz tube under N₂ atmosphere and moved to 300 nm light. A soft crosslinked film was formed upon 1-hour light irradiation, while a hard crosslinked film was formed upon 960 min light irradiation.

TABLE 1
Table of Resin Components in FIG. 3C.
Photobuffer TBACl:

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 20 | 2.8 | 0.26 | ml |
| ECC | 20 | 2.8 | 0.62 | ml |

TABLE 2
Photobuffer TBAPCCP.

| Reagents | Equivalence | mmol | Volume | |
|---|---|---|---|---|
| CQ | 1 | 0.14 | | mg |
| EDMAB | 1 | 0.14 | 27 | mg |
| TBAPCCP | 0.5 | 0.07 | 41.8 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 20 | 2.8 | 0.26 | ml |
| ECC | 20 | 2.8 | 0.62 | ml |

TABLE 3
Photobuffer TBABr.

| Reagents | Equivalence | mmol | Volume | |
|---|---|---|---|---|
| CQ | 1 | 0.14 | 23.2 | mg |
| EDMAB | 1 | 0.14 | 27 | mg |
| TBABr | 0.5 | 0.07 | 22.6 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 20 | 2.8 | 0.26 | ml |
| ECC | 20 | 2.8 | 0.62 | ml |

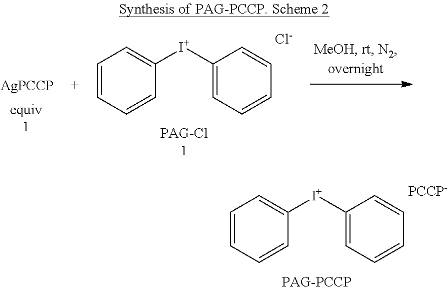

A 25 mL round bottom flask was dried and charged with PAG-Cl (206 mg, 0.64 mmol), and 2 mL anhydrous MeOH solution. AgPCCP (300 mg, 0.64 mmol) was dissolved in a minimum amount of MeOH (˜2.5 mL) before adding to PAG-Cl. The reaction was stirred for 9 h wrapped with aluminum foil. The reaction was filtered, concentrated, and dried under high vacuum overnight to get PAG-PCCP (89% yield). ¹H NMR (400 MHz, CD₃OD): 3.70 ppm (s, 15H), 7.51 ppm (t, 4H), 7.68 ppm (t, 2H), 8.12 ppm (d, 4H).

TABLE 4
Photobuffer TBAOAc.

| Reagents | Equivalence | mmol | Volume | |
|---|---|---|---|---|
| CQ | 1 | 0.14 | 23.2 | mg |
| EDMAB | 1 | 0.14 | 27 | mg |
| TBAOAc | 0.5 | 0.07 | 21.1 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 20 | 2.8 | 0.26 | ml |
| ECC | 20 | 2.8 | 0.62 | ml |

TABLE 5
Table of Resin Components in FIG. 3D.
100:1 MA:TEGDA.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 20 | 2.8 | 0.26 | ml |
| ECC | 20 | 2.8 | 0.62 | ml |

TABLE 6
90:10 MA:TEGDA.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 90 | 12.6 | 1.14 | ml |
| TEGDA | 10 | 1.4 | 0.38 | ml |
| CHO | 20 | 2.8 | 0.26 | ml |
| ECC | 20 | 2.8 | 0.62 | ml |

TABLE 7
70:30 MA:TEGDA.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 70 | 26.1 | 0.88 | ml |
| TEGDA | 30 | 4.2 | 1.13 | ml |
| CHO | 20 | 2.8 | 0.26 | ml |
| ECC | 20 | 2.8 | 0.62 | ml |

TABLE 8
Table of Resin Components in FIG. 3E.
5 equiv epoxide.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 5 | 0.7 | 0.06 | ml |
| ECC | 5 | 0.7 | 0.16 | ml |

TABLE 9
10 equiv epoxide.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 10 | 1.4 | 0.13 | ml |
| ECC | 10 | 1.4 | 0.31 | ml |

TABLE 10
20 equiv epoxide.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 20 | 2.8 | 0.26 | ml |
| ECC | 20 | 2.8 | 0.62 | ml |

TABLE 11
40 equiv epoxide.

| Reagents | Equivalence | mmol | Volume | |
|---|---|---|---|---|
| CQ | 1 | 0.14 | 23.2 | mg |
| EDMAB | 1 | 0.14 | 27 | mg |
| TBACl | 0.5 | 0.07 | 19.5 | mg |
| PAG-ISbF₆ | 1 | 0.14 | 90.4 | mg |
| MA | 160 | 22.4 | 2.02 | ml |
| TEGDA | 1.6 | 0.224 | 0.06 | ml |
| CHO | 40 | 5.6 | 0.52 | ml |
| ECC | 40 | 5.6 | 1.24 | ml |

GC Experiments and Results. Sample preparation. In a nitrogen filled glovebox, CQ (5.8 mg, 35 μmol, I equiv), EDMAB (6.7 mg, 35 μmol, 1 equiv), TBACl (4.9 mg, 18 μmol, 0.5 equiv), PAG-ISbF₆ (22.0 mg, 35 mol, 1 equiv), MA (0.51 mL, 5.6 mmol, 160 equiv), TEGDA (15 μL, 56 mol, 1.6 equiv), CHO (0.14 mL, 1.4 mmol, 40 equiv), ECC (0.15 mL, 0.70 mmol, 20 equiv), and OXAA (0.05 mL, 0.24 mmol, 7 equiv) were combined in a 2.5 cm×2.5 cm silicone mold. The solution was mixed until homogenous and capped with a Petri dish before removal from glovebox. The reaction mixture was irradiated with a blue Kessil lamp while cooling with compressed air. At two different timepoints (30 s, 60 m), the reaction mixture was removed from the light source, opened to air, and quenched with 0.25 mL 5% NEt₃ in PrOH. Three 0.5 cm×0.5 cm squares (0.04x the area of the total film) were cut from each film and swelled in 1 mL DCM. After swelling for 16 h, 0.6 mL of each supernatant was combined with 0.15 mL DCM and 2.3 μL anisole as an internal standard.

Sample preparation (0 s light irradiation). To quantify the starting material at t=0, three 0.03 mL aliquots of the reaction mixture (0.04x the volume of the total solution) were 5 diluted into vials containing 1 mL of DCM. Then, 0.6 mL of the diluted solutions were combined with 0.15 mL DCM and 2.3 μL anisole as an external standard.

Cyclic Tensile Testing Experiment and Results. In a nitrogen filled glovebox, an oven-dried reaction vessel was charged with CQ (25.7 mg, 0.16 mmol, 1 equiv), EDMAB (30 mg, 0.16 mmol, 1 equiv), TBACl (21.6 mg, 0.08 mmol, 0.5 equiv), PAG-ISbF₆ (100.4 mg, 0.16 mmol, 1 equiv), MA (2.24 ml, 25.6 mmol, 160 equiv), TEGDA (0.067 ml, 0.256 mmol, 1.6 equiv), CHO (0.3 ml, 3.2 mmol, 20 equiv), ECC (0.68 ml, 3.2 mmol, 20 equiv), and OXAA (0.22 ml, 1.12 mmol, 7 equiv). The vessel was sealed with a clamp under a nitrogen atmosphere and removed from glovebox, then irradiated with a blue Kessil lamp (456 nm, 25% light intensity) while cooling by blowing compressed air. After 10 s, the vessel was moved to a blue Thorlabs collimated LED (455 nm, 500 mW, 9.1 mW/cm²) equipped with two convex lens and a photomask to focus light to a pattern on the polymer film. After 1 hour irradiation, the vessel was opened to air. The crosslinked film was cut into a dogbone shape before cyclic tensile testing.

Cyclic tensile testing procedures. DMA Experiments and Results. In a nitrogen filled glovebox, an oven-dried reaction vessel was charged with CQ (25.7 mg, 0.16 mmol, 1 equiv), EDMAB (30 mg, 0.16 mmol, 1 equiv), TBACl (21.6 mg, 0.08 mmol, 0.5 equiv), PAG-ISbF₆ (100.4 mg, 0.16 mmol, 1 equiv), MA (2.24 ml, 25.6 mmol, 160 equiv), TEGDA (0.067 ml, 0.256 mmol, 1.6 equiv), CHO (0.3 ml, 3.2 mmol, 20 equiv), ECC (0.68 ml, 3.2 mmol, 20 equiv), and OXAA (0.22 ml, 1.12 mmol, 7 equiv). The vessel was sealed with a clamp under a nitrogen atmosphere and removed from glovebox, then irradiated with a blue Kessil lamp (456 nm, 25% light intensity, 23 mW/cm²) while cooling by blowing compressed air. After 10 s, the vessel was moved to a blue Thorlabs collimated LED (455 nm, 500 mW, 9.1 mW/cm²) equipped with two convex lens and a photomask to focus light to only the middle region of the crosslinked film. After 1 hour irradiation, the vessel was opened to air. The crosslinked film was cut into 6.4 mm×2.7 mm×1.5 mm (hard) and 6.4 mm×3.7 mm×1.5 mm (soft) strips for DMA.

Rheology Experiments and Results. In a quartz tube, PAG-PCCP (3.25 mg, 0.005 mmol, 0.5 equiv), HBD (3.65 mg, 0.005 mmol, 0.5 equiv), BCY (11.3 mg, 0.05 mmol, 5 equiv), and PAG-ISbF₆ (6.45 mg, 0.01 mmol, 1 equiv) were added and dried on vacuum. Then IBVE (0.13 ml, 1 mmol, 100 equiv), BDVE (0.01 ml, 0.08 mmol, 9 equiv), and CL (0.11 ml, 1 mmol, 100 equiv) were added to the quartz tube under N₂ atmosphere and moved to 300 nm light. A soft crosslinked film was formed upon 1-hour light irradiation, and a hard crosslinked film was formed upon 960 min light irradiation. The films were cut into 8 mm discs for rheology.

### Example 2

This example describes polymerizable compositions and polymerization methods of the present disclosure, and uses thereof. A hydrogen bond donor (HBD) was used to catalyze photoinitiated cationic polymerizations from PAGs with coordinating anions such as Cl⁻ and OAc. Through the formation of hydrogen bonds with HBDs, the basicity of anions was significantly lowered, thus accelerating the propagation of cationic polymers. The addition of HBD to coordinating anion-containing PAGs diminished the ion affinity to the growing cationic polymer chain ends, promoting accelerated polymerization rates.

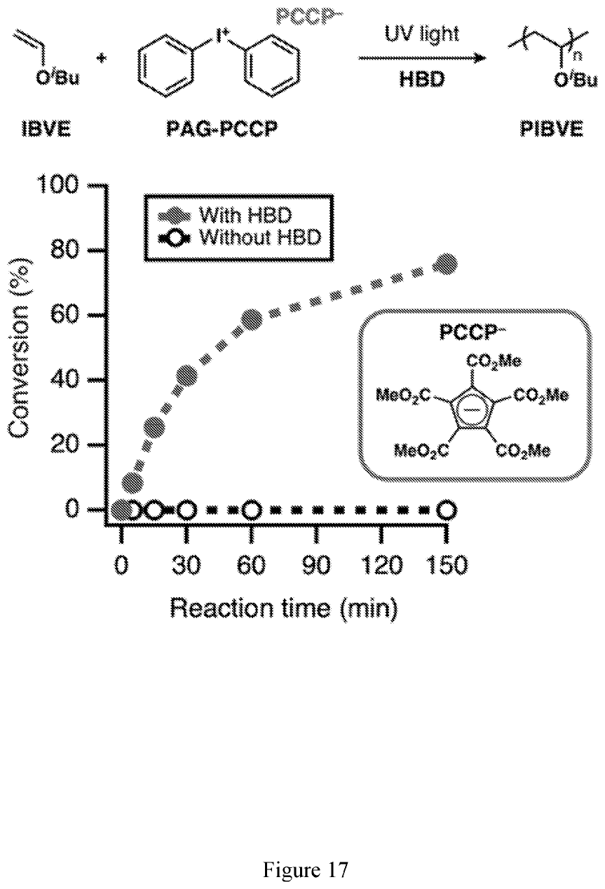

Experimental results. A diphenyliodonium PAG with a PCCP counteranion (PAG-PCCP) was initially used, as previous studies demonstrated the ability of HBD to catalyze PCCP acid initiated cationic polymerizations. As a control, 200 equiv of isobutyl vinyl ether (IBVE) was added to 1 equiv of PAG-PCCP and irradiated with 300 nm UV light. No polymerization was observed after 150 minutes of light irradiation, indicating that the acid generated by PAG-PCCP was not sufficient to polymerize IBVE. However, adding 1 equiv of a thiophosphoramide HBD led to a 76% IBVE monomer conversion after 150 min of light irradiation (FIG. 17). This is likely a result of the HBD pulling electron density from the PCCP anion and thus chain end, allowing for propagation.

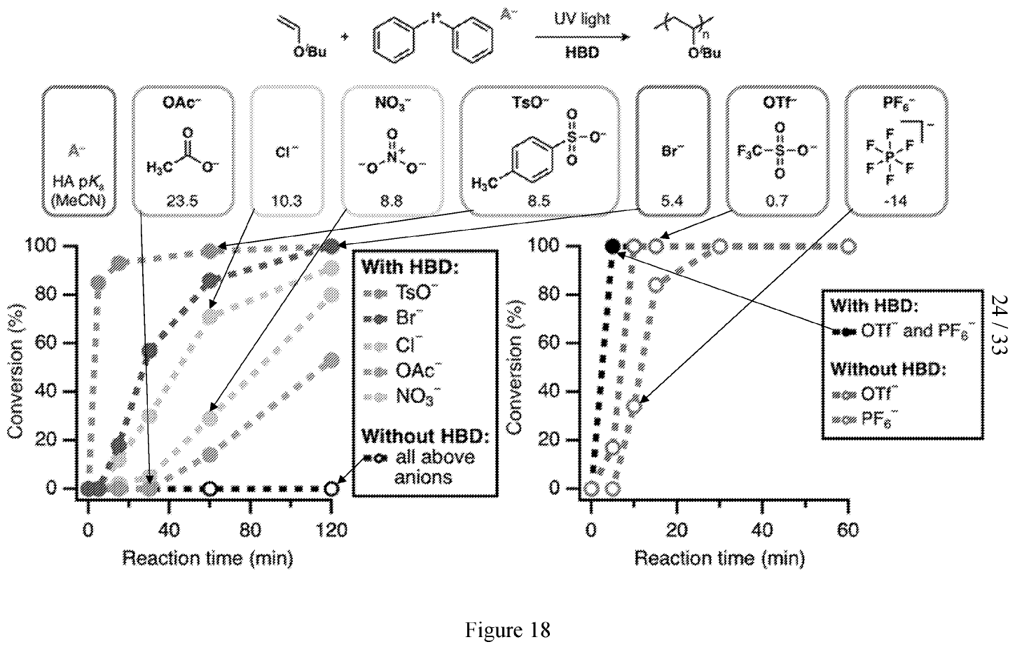

To test the breadth of the system, we selected commercially available PAGs with anions that result in conjugate acids with a variety of pKas including: hexafluorophosphate (PF₆⁻), triflate (OTf⁻), bromide (Br⁻), tosylate (TsO⁻), nitrate (NO₃⁻), chloride (Cl⁻), and acetate (OAc⁻). When these PAGs were exposed to UV light in the presence of IBVE without HBD, PAG-PF₆ and PAG-OTf reached full conversion in under 30 minutes, while the other anions were unable to initiate polymerization after 120 minutes. Taking the anions unable to initiate polymerization, we probed the effects of 1 equiv HBD on the various counteranions of the PAGs. As with the PCCP counteranion, some polymerization was observed within 120 minutes, with the rates trending as TsO⁻>Br⁻>Cl⁻>NO₃⁻>OAc⁻ (FIG. 18). Even the anions PF₆⁻ and OTf⁻ that saw polymerization without HBD experienced faster polymerization rates upon the addition of HD (FIG. 18).

In general, the polymerization kinetics correlate with the acidity of the Bronsted acids generated from PAGs. Acids with lower pKₐ values in MeCN resulted in faster polymerization rates. However, solely based on pKₐ, both bromide and nitrate saw less rate acceleration than predicted. Interestingly, the polymerization with PAG-TsO and HBD achieved similar polymerization kinetics as the reactions of PAG-OTf and PAG-PF₆ without HBD, despite tosylic acid having a much higher pKₐ. Therefore, this has the potential to provide a fluorine-free alternative to the current commercially-used standard for fast photoinitiated cationic polymerizations.

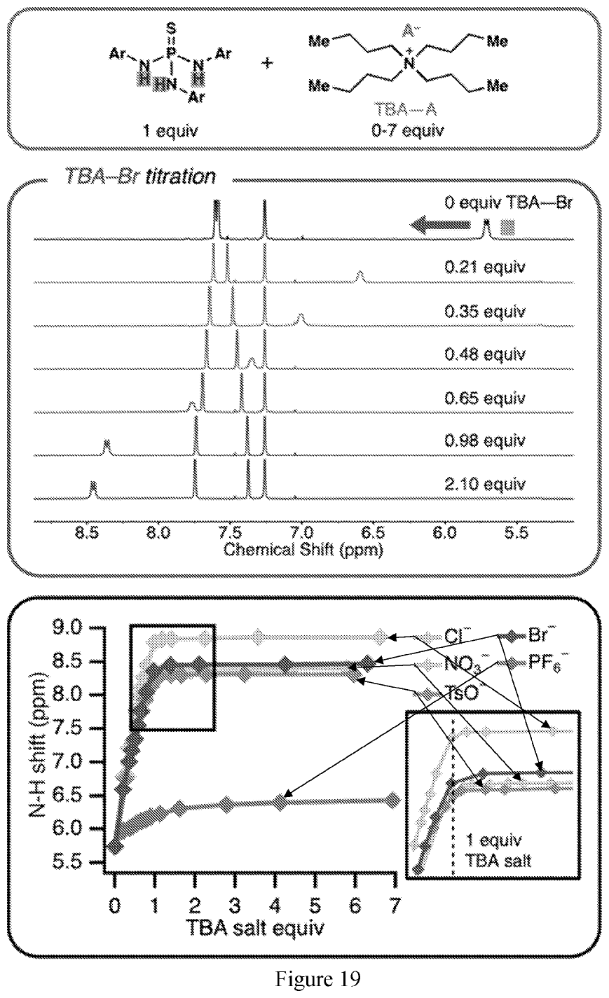

In order to investigate the reasons behind these trends, ¹H-NMR titrations were performed with HBD as the host and with increasing amounts of anion added in the form of the tetrabutylammonium (TBA) salts. The amine protons on the HBD were tracked as the signal moved downfield with increasing anion concentration. The more coordinating anions reached saturation around 1 equivalence with respect to HBD, indicating that there is 1:1 binding of the anion to the hydrogen bond donor (FIG. 19). Titrations with PCCP anion and acetate were unsuccessful as the N—H signal broadened into the baseline, which has previously been reported as deprotonation instead of binding (cite). In contrast, the weakly coordinating anion PF-continued to shift the N—H protons downfield with 7 equivalents of TBA salt to HBD, indicating that the system was not fully saturated even at large excess. Therefore, with the data from tosylate, bromide, chloride, and nitrate, the binding constants (K_{eq}) were approximated by fitting the data to the equation for 1:1 binding (SI). The resulting fits gave K_{eq}s in the order of TsO⁻≅NO₃⁻>Br⁻≅Cl⁻. From these approximations, tosylate binds more strongly to the HBD than bromide and chloride. With stronger binding, the HBD can draw more electron density from TsO⁻, weakening the anion's binding to the oxocarbenium chain and allowing for higher rates of propagation. As bromide and chloride have similar binding constants for HBD, the similar reaction kinetics also align with the titration data, despite the differences in their pKₐs.

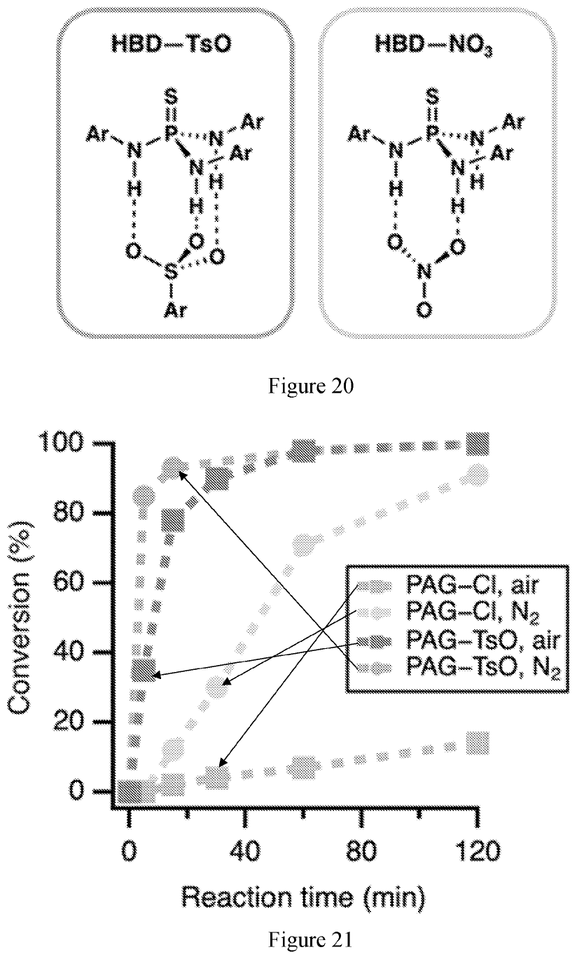

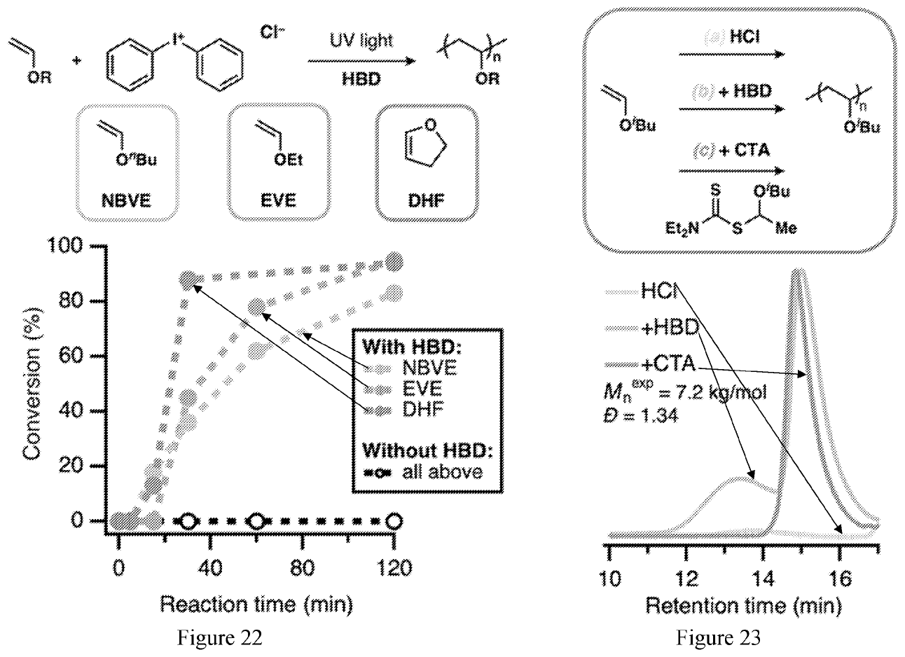

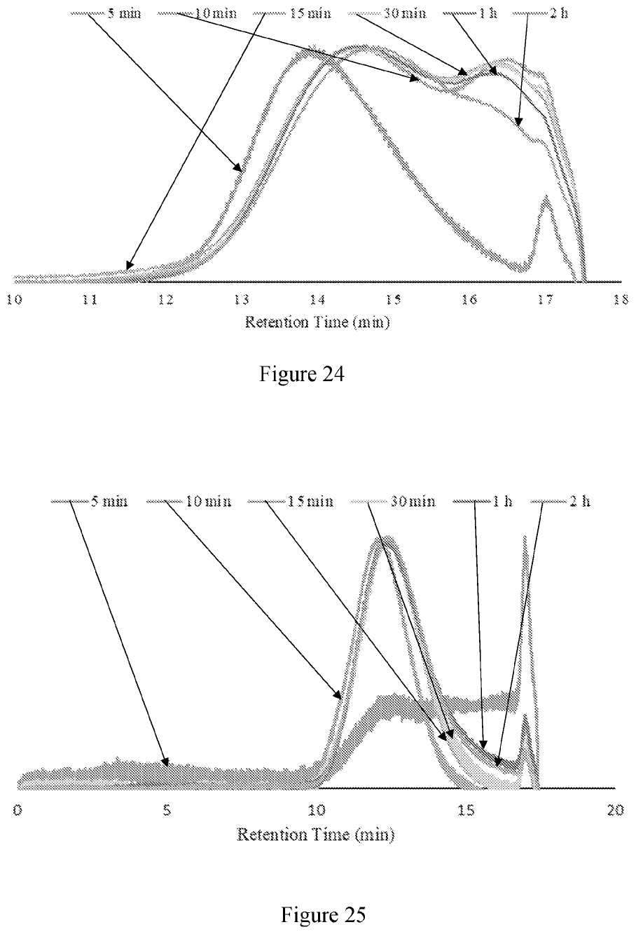

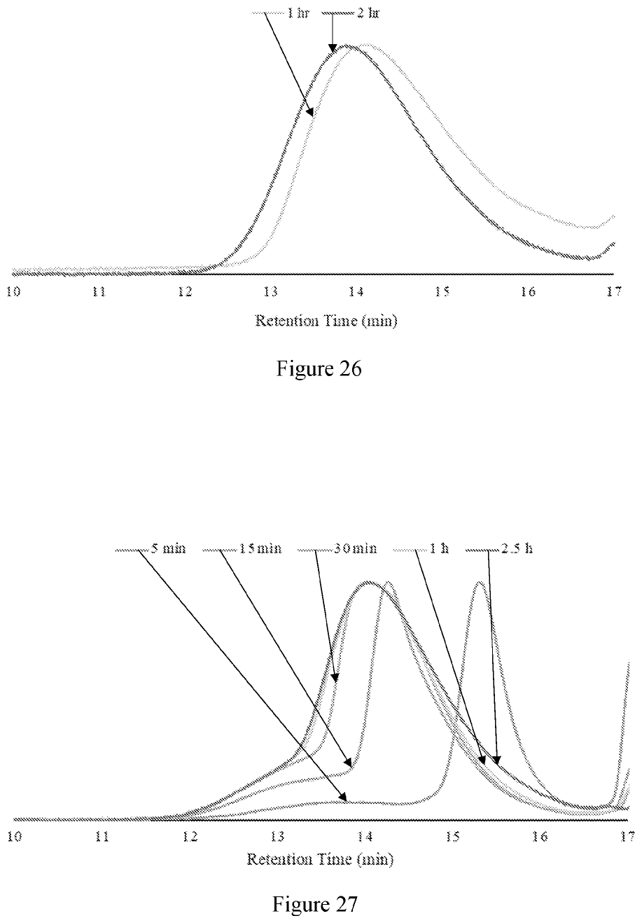

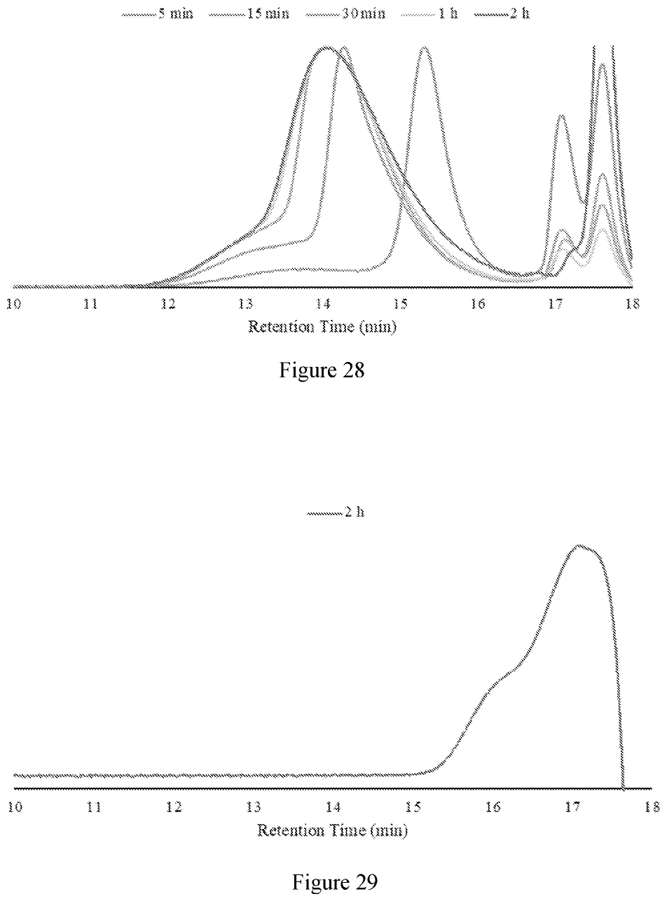

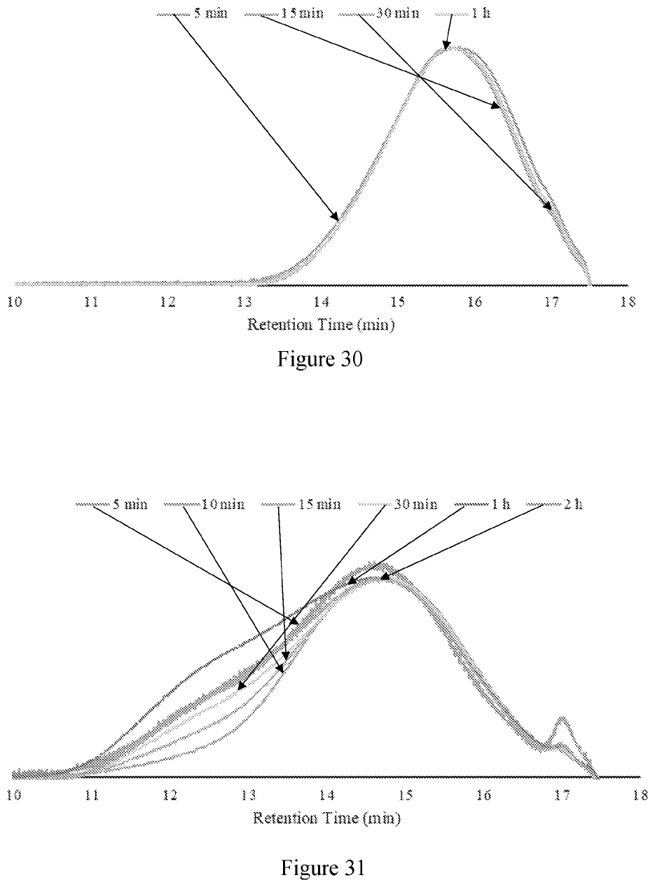

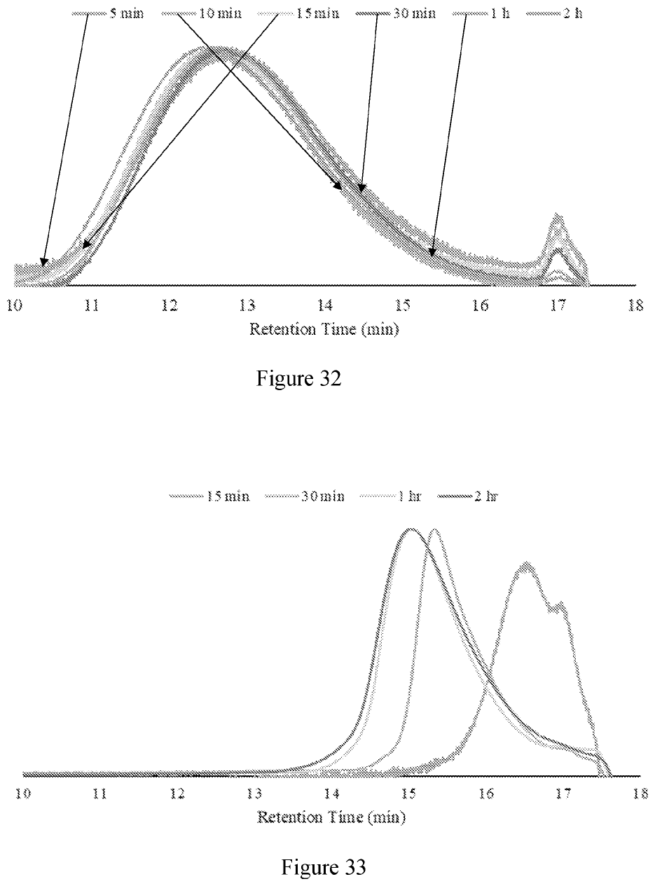

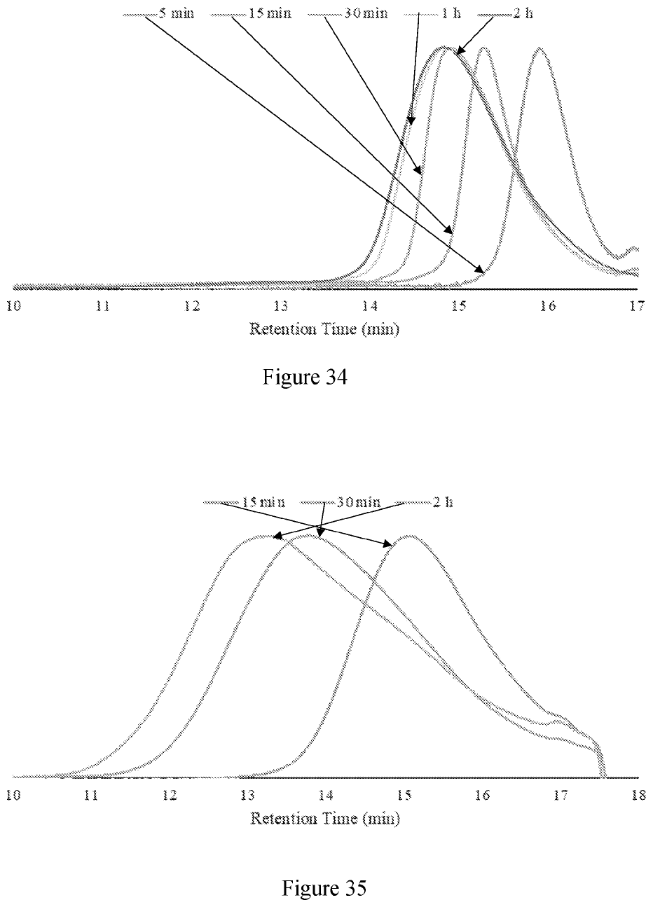

However, the titration data is unable to explain the experimental differences between the tosylate and nitrate PAGs. Despite nitric acid having a similar pKₐ to tosylic acid, the PAG-NO₃ polymerization was significantly slower, reaching 80% conversion after 2 hours, whereas the PAG-OTs reached 85% conversion after 5 minutes of light irradiation. We hypothesized that the tetrahedral geometry of the sulfate group on the tosylate anion allowed for increased coordination to the tetrahedral shape of the hydrogen bond donor, compared to the trigonal planar geometry of the nitrate anion. After geometry optimizations with density functional theory (DFT), one of the minimum energy states for binding between the HBD and tosylate anion corresponded to the oxygens of the sulfate group on TsO⁻ hydrogen bonding to all three of the hydrogens of the amines on the HBD. However, geometry optimizations between the nitrate anion and HBD resulted in only two hydrogen bonds between the oxygens on NO₃⁻ and the hydrogens of the N—Hs on the HBD (FIG. 20). As the Fors group as previously shown (cite HBD paper), the ability to coordinate to all three sites on the HBD increases the rate of polymerization compared to binding to just two sites. Therefore, it is likely the geometry mismatch between the nitrate anion and HBD that leads to reduced polymerizations rates.

To further improve the feasibility of this system, the polymerizations were performed under air. Once again, PAG-TsO with 1 equiv HBD displayed the fastest kinetics, achieving 90% conversion after 30 min (FIG. 21). Despite reacting under ambient conditions, the polymerization still reached full conversion within 2 hours. However, when PAG-Cl (FIG. 21) and PAG-PCCP (FIG. 21) were polymerized with 1 equiv of HBD under air, a major reduction in rate was observed, reaching only 14% and 3% conversion respectively. This more dramatic decrease in kinetics is likely due to the slower kinetics originally observed for PAG-Cl and PAG-PCCP under nitrogen, giving more time for deleterious effects from air.

A variety of vinyl ethers were studied to show the monomer scope of HBD catalyzed cationic polymerizations: ethyl vinyl ether (EVE), n-butyl vinyl ether (NBVE), and 2,3-dihydrofuran (DHF). PAG-Cl was utilized to explore the boundaries of the weaker acids generated in this system. Without HBD, no polymerization was observed for these vinyl ethers and PAG-Cl. The EVE polymerization did undergo some monomer conversion to side products as a result of acid-catalyzed hydrolysis to form acetaldehyde and acetals. Upon the addition of 1 equiv of hydrogen bond donor, all monomers achieved high conversions after 120 minutes. DHF saw the greatest rate increase, achieving almost fully consumption after 30 minutes (88% conversion). Interestingly, for EVE in the presence of HBD, all monomer conversion was to polymer, with no degradation to acetal side products observed by ¹H-NMR. The monomer scope demonstrates the potential range of physical properties of the resulting polymers, as they have reported glass transition temperature ranging from −50° C. to 135° C.

Since the rate acceleration was seen with PCCP both in its PAG anionic form as well as its Bronsted acid form, we hypothesized that the other corresponding Bronsted acids that are unable to initiate vinyl ether polymerizations alone could be catalyzed by the addition of HBD. To test this, 1 equiv of hydrochloric acid (HCl) was added to 150 equiv of IBVE. Confirmed by ¹H-NMR, no polymerization was observed, although there was conversion of IBVE to acetal side products via hydrolysis. Upon the addition of 0.5 equiv of HBD to these conditions, the reaction reached full conversion after 3.5 hours, yielding polymers with a bimodal distribution (FIG. 23). In order to impart control, 1 equiv of a dithiocarbamate chain transfer agent (CTA) was added, and the amount of HCl was dropped to 0.5 equiv to match that of the HBD. Similar conditions with PCCP acid in a RAFT system have demonstrated tolerance to ambient conditions. Therefore, these experiments were performed under air without monomer purification. Despite the lack of drying, after 4 hours, these polymerizations conditions resulted in polymers with a dispersity of 1.34 and an experimental Mₙ=7.2 kg/mot, matching the theoretical Mₙ=7.5 kg/mol. When no HBD was added under the same reaction conditions, no polymerization was seen after 2 days, with 12% conversion to degradation products. With these results, HBD has the potential to catalyze many cationic polymerization methods with coordinating anions at the chain end.

We developed a HBD catalyzed photopolymerizations of vinyl ethers using PAGs that previously were unable to initiate vinyl ethers in reasonable time scales. Through the formation of hydrogen bonding, the PAG anion's affinity to the growing cationic polymer chain ends was reduced, promoting accelerated polymerization rates. Expanding these reaction conditions to different monomers and atmospheres may increase the feasibility of this method for the fabrication of polymer materials with tunable physical properties. Furthermore, we showed initial results that this concept can be applied to cationic polymerizations beyond those initiated by PAG. This could advance fluorine-free photolithography and 3D printing technologies.

General Reagent Information. Diphenyliodonium chloride (PAG-Cl, 98%, TCI), diphenyliodonium nitrate (PAG-NO₃, TCI), diphenyliodonium trifluoromethanesulfonate (PAG-OTf, 98%, TCI), diphenyliodonium p-toluenesulfonate (PAG-pTsO, 95%, 99%, Millipore Sigma), (TBAOAc,), tetrabutylammonium bromide (TBABr, 98%, Sigma Aldrich), tetrabutylammonium chloride (TBACl, 97%, Sigma Aldrich), tetrabutylammonium nitrate (TBANO₃, 97%, Alfa Aesar), tetrabutylammonium p-toluenesulfonate (PAG-pTsO, Fluka Chemical), and silver acetate (AgOAc, Sigma Aldrich) were used as received. Isobutyl vinyl ether (IBVE, 99%, TCI), ethyl vinyl ether (EVE, 98%, TCI), butyl vinyl ether (NBVE, contains 0.01% potassium hydroxide as stabilizer, 98%, Sigma Aldrich), and 2,3-dihydrofuran (DHIF) (99%, TCI) were dried over calcium hydride (CaH₂) (ACROS organics, 93% extra pure, 0-2 mm grain size) overnight, distilled under nitrogen followed by 3 freeze-pump thaw cycles and then stored in the glove box freezer (−35° C.). 1,2,3,4,5-Pentacarbomethoxycyclopentadiene (PCCPH) and tris(3,5-bis(trifluoromethyl)phenyl) thiophosphotriamide (HBD) were synthesized according to a reported literature procedure.

General Analytical Information. Nuclear magnetic resonance (NMR) spectra were recorded on a Bruker 500 MHz instrument.

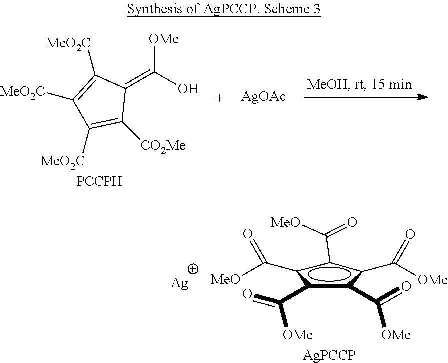

A 250 ml round bottom flask was charged with AgOAc (0.338 g, 2.02 mmol) and 20 ml anhydrous MeOH. PCCPH (0.722 g, 2.02 mmol) was dissolved in 44 ml of MeOH and added to the AgOAc solution. The reaction was stirred for 15 min before filtering out the solid impurity. The resulted solution was concentrated down on rotovap and dry on high vac overnight wrapped in aluminum foil to avoid light.

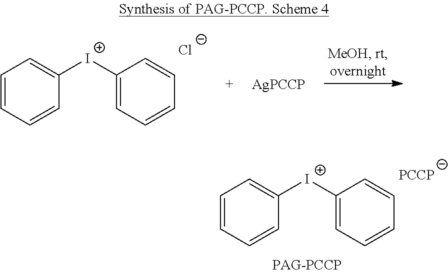

A round bottom flask was dried and charged with PAG-Cl (206 mg, 0.64 mmol), and 2 ml anhydrous MeOH solution. AgPCCP (300 mg, 0.64 mmol) was dissolved in a minimum amount of MeOH before adding to PAG-Cl. The reaction was stirred overnight while wrapped with aluminum foil. The next day the reaction was filtered and concentrated to get PAG-PCCP.

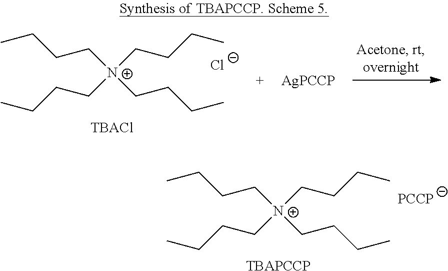

A round bottom flask was dried and charged with AgPCCP (160 mg, 0.35 mmol), and 2.5 ml anhydrous acetone. TBACl (102 mg, 0.3675 mmol) was added to AgPCCP solution and stirred overnight. The reaction was filtered and concentrated to the product TBAPCCP.

General Procedures for IBVE Polymerizations Using PAGs Without HBD. In an oven-dried quartz tube, 1 equiv of PAG salt was added and dried on vacuum. Then IBVE (0.52 15 ml, 4 mmol, 200 equiv) was added to the reaction tube under N₂ atmosphere and moved to 300 nm light. Aliquots for ¹H NMR analysis were taken at desired light irradiation time points.

PAG-OAc. In an oven-dried quartz tube, PAG-OAc (6.8 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis 20 were taken at 15 min, 1 h, 2 h.

PAG-PCCP. In an oven-dried quartz tube, PAG-PCCP (13 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 15 min, 1 h, 2 h.

PAG-Cl. In an oven-dried quartz tube, PAG-Cl (6.3 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 15 min, 30 min, 1 h, 2 h.

PAG-NO₃. In an oven-dried quartz tube, PAG-NO₃ (6.8 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 15 min, 30 min, 1 h, 2 h.

PAG-pTsO. In an oven-dried quartz tube, PAG-pTsO (9 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 2 h.

PAG-Br. In an oven-dried quartz tube, PAG-Br (7.2 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2 h.

PAG-OTf. In an oven-dried quartz tube, PAG-OTf (8.6 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 10 min, 15 min, 30 min, 1 h, 2 h.

PAG-PF₆. In an oven-dried quartz tube, PAG-PF₆ (8.5 mg, 0.02 mmol, 1 equiv) was added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 10 min, 15 min, 30 min, 1 h, 2 h.

General Procedures for IBVE Polymerizations Using PAGs with HBD. In an oven-dried quartz tube, 1 equiv of PAG salt and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at desired light irradiation time points.

PAG-OAc. In an oven-dried quartz tube, PAG-OAc (6.8 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2 h.

PAG-PCCP. In an oven-dried quartz tube, PAG-PCCP (13 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2.5 h.

PAG-Cl. In an oven-dried quartz tube, PAG-Cl (6.3 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2 h.

PAG-NO₃. In an oven-dried quartz tube, PAG-NO₃ (6.8 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2 h.

PAG-pTsO. In an oven-dried quartz tube, PAG-pTsO (9 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2 h.

PAG-Br. In an oven-dried quartz tube, PAG-Br (7.2 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 15 min, 30 min, 1 h, 2 h.

PAG-OTf. In an oven-dried quartz tube, PAG-OTf (8.6 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 10 min, 15 min, 30 min, 1 h, 2 h.

PAG-PF₆. In an oven-dried quartz tube, PAG-OTf (8.5 mg, 0.02 mmol, 1 equiv) and HBD (15 mg, 0.02 mmol, 1 equiv) were added and dried on vacuum. Then IBVE (0.52 ml, 4 mmol, 200 equiv) was added to the reaction tube under N₂ atmosphere and moved to 300 nm light. Aliquots for ¹H NMR analysis were taken at 5 min, 10 min, 15 min, 30 min, 1 h, 2 h.

General Procedures for Polymerizations of Vinyl Ethers with PAG-Cl Without HBD. In an oven-dried quartz tube, PAG-Cl (6.3 mg, 0.02 mmol, 1 equiv) was added and dried on vacuum. Then the respective vinyl ether monomer (200 equiv) was added to the reaction tube under N₂ atmosphere and moved to 300 nm light. Aliquots for ¹H NMR analysis were taken at desired irradiation time.

General Procedures for Polymerizations of Vinyl Ethers with PAG-Cl and HBD. In an oven-dried quartz tube, PAG-Cl (6.3 mg, 0.02 mmol, 1 equiv) and HBD (15 mg, 0.02 mmol, 1 equiv) were added and dried on vacuum. Then the respective vinyl ether monomer (200 equiv) was added to the reaction tube under N₂ atmosphere and moved to 300 nm light. Aliquots for ¹H NMR analysis were taken at desired irradiation time.

Although the present disclosure has been described with respect to one or more particular examples, it will be understood that other examples of the present disclosure may be made without departing from the scope of the present disclosure.

1. A polymerization method comprising:
irradiating a polymerizable composition comprising:
one or more first monomer(s);
one or more second monomer(s);
one or more first polymerization agent(s);
one or more second polymerization agent(s); and
optionally, one or more hydrogen bond donor(s),
with a first dosage of light comprising a first wavelength of light,
wherein at least a portion of the first monomer(s) is/are polymerized and substantially none or none the second monomer(s) is/are polymerized.

2. The polymerization method of claim 1, the method further comprising irradiating the irradiated polymerization composition with a second dosage of light comprising a second wavelength of light, wherein at least a portion of the second monomer is polymerized, and the first wavelength and the second wavelength are substantially the same.

3. The polymerization method of claim 1, wherein
i) the pH of the polymerizable composition comprises a first pH prior to and/or during the irradiating of the polymerizable composition and/or a second pH prior to and/or during the irradiating of the irradiated polymerizable composition, and
the first pH is different than the second pH; or
ii) the pH of the polymerizable composition comprises a first pH prior to the irradiating of the polymerizable composition, a second pH during or after irradiating of the polymerizable composition, and a third pH during or after the irradiating of the irradiated polymerizable composition, wherein the first pH, second pH, and third pH are all different.

4. The polymerization method of claim 1, wherein the polymerization of the first monomer is a radical polymerization or a cationic polymerization.

5. The polymerization method of claim 1, wherein the first polymerization agent(s) is/are chosen from photosensitizers, photoacid generators, and any combination thereof.

6. The polymerization method of claim 5, one or more or all of the first polymerization agent(s) comprise one or more coordinating anion(s).

7. The polymerization method of claim 6, wherein the one or more coordinating anion(s) is/are chosen from halides, pentacarbomethoxycyclopentadienes (PCCP⁻s), carboxylates, structural analogs thereof, and any combination thereof.

8. The polymerization method of claim 1, wherein the first monomer(s) is/are chosen from radical polymerization monomers, cationic polymerization monomers, and any combination thereof.

9. The polymerization method of claim 1, wherein the polymerization of the second monomer is a cationic polymerization.

10. The polymerization method of claim 1, wherein the second polymerization agent(s) is/are chosen from photoacid generators and any combination thereof.

11. The polymerization method of claim 10, wherein one or more or all of the photoacid generator(s) comprise one or more non-coordinating anion(s).

12. The polymerization method of claim 11, wherein the polymerizable composition further comprises one or more salt(s), each salt comprising one or more coordinating anion(s).

13. The polymerization method of claim 10, wherein the mole ratio of coordinating anion(s) to photoacid generator(s) is about 1:1 to about 0.01:1.

14. The polymerization method of claim 1, wherein the second monomer(s) is/are chosen from cationic polymerization monomers and any combination thereof.

15. The polymerization method of claim 1, wherein the polymerizable composition comprises one or more crosslinking monomer(s).

16. The polymerization method of claim 1, wherein
i) the first monomer(s) is/are chosen from radical polymerization monomers and any combination thereof and/or the first polymerization agent(s) is/are chosen from photosensitizers any combination thereof, and/or the first monomer is polymerized by a radical polymerization, and/or
the second monomer(s) is/are chosen from cationic polymerization monomers and any combination thereof and/or the second polymerization agent comprises a photoacid generator or photoacid generators and/or the second monomer is polymerized by a cationic polymerization;
ii) the wherein the first monomer(s) is/are chosen from cationic polymerization monomers and any combination thereof and/or the first polymerization agent comprises a photoacid generator or photoacid generators and coordinating anion(s) and/or organic salts/inorganic salts comprising one or more coordinating anion(s) and/or the first monomer is polymerized by a cationic polymerization, and/or
the second monomer(s) is/are chosen from cationic monomers and any combination thereof and/or the second polymerization agent comprises a photoacid generator or photoacid generators each comprising one or more non-coordinating anion(s) and/or the second monomer is polymerized by a cationic polymerization.

17. The polymerization method of claim 1, wherein the polymerizable composition further comprises one or more chain transfer agent(s), the method further comprises functionalizing the polymer product formed as a result of the irradiating of the polymerizable composition and/or irradiation of the irradiated polymerizable composition.

18. A polymerizable composition comprising:
one or more first monomer(s);
one or more second monomer(s);
one or more first polymerization agent(s);
one or more second polymerization agent(s); and
optionally, one or more hydrogen bond donor(s).

19. The polymerizable composition of claim 18, wherein the first monomer(s) is/are chosen from radical polymerization monomers, cationic polymerization monomers, and any combination thereof.

20. The polymerizable composition of claim 19, wherein the radical polymerization monomer(s) is/are chosen from acrylates, methacrylates, acrylamides, vinyl carboxylates, styrenes, structural analogs thereof, and any combination thereof.

21. The polymerizable composition of claim 19, wherein the cationic polymerization monomer(s) is/are chosen from vinyl ethers, epoxides, lactones, cyclic acetals, heterocyclic acetals, structural analogs thereof, and any combination thereof.

22. The polymerizable composition of claim 18, wherein the first polymerization agent(s) is/are chosen from photosensitizers, photoacid generators, and any combination thereof.

23. The polymerizable composition of claim 22, wherein the photosensitizer(s) is/are chosen from thioflavin T, riboflavin, diphenyl (2,4,6-trimethylbenzoyl) phosphine oxide, acridine orange, Rose Bengal, H-Nu470, champhorquinone, zinc tetraphenylporphyrin, structural analogs thereof, and any combination thereof.

24. The polymerizable composition of claim 22, wherein the photoacid generator(s) is/are chosen from triarylsulfonium salts, diaryliodonium salts, structural analogs thereof, and any combination thereof.

25. The polymerizable composition of claim 22, wherein one or more or all of the photoacid generator(s) comprise(s) one or more coordinating anion(s).

26. The polymerizable composition of claim 25, wherein the one or more coordinating anion(s) are chosen from halides, pentacarbomethoxycyclopentadienes (PCCP⁻s), carboxylates, structural analogs thereof, and any combination thereof.

27. The polymerizable composition of claim 18, wherein the second monomer(s) is/are chosen from cationic polymerization monomers and any combination thereof.

28. The polymerizable composition of claim 27, wherein cationic polymerization monomer(s) is/are chosen from epoxides, lactones, cyclic acetals, heterocyclic acetals, structural analogs thereof, and any combination thereof.

29. The polymerizable composition of claim 18, wherein the second polymerization agent(s) is/are chosen from photoacid generators (which, independently, may comprise one or more non-coordinating anion(s)), and any combination thereof.

30. The polymerizable composition of claim 29, wherein one or more or all of the photoacid generator(s) comprise one or more non-coordinating anion(s).

31. The polymerizable composition of claim 30, wherein the one or more non-coordinating anion(s) are chosen from PF₆⁻, SbF₆⁻, ClO₄⁻, CF₃SO₃⁻ structural analogs thereof, and any combination thereof.

32. The polymerizable composition of claim 29, wherein one or more or all the second polymerization agent(s) is/are a photoacid generator, the composition further comprises one or more salt(s), each salt comprising one or more coordinating anion(s).

33. The polymerizable composition of claim 32, wherein the coordinating anions are chosen from halides, pentacarbomethoxycyclopentadienes (PCCP⁻s), carboxylates, structural analogs thereof, and any combination thereof.

34. The polymerizable composition of claim 32, wherein the mole ratio of coordinating anion(s) to photoacid generator(s) is about 1:1 to about 0.01:1.

35. The polymerizable composition of claim 32, wherein the one or more salt(s) is/are chosen from a tetraalkylammonium salts comprising one or more coordinating anion(s).

36. The polymerizable composition of claim 18, wherein the polymerizable composition further comprises one or more crosslinking monomer(s).

37. The polymerizable composition claim 18, wherein the polymerizable composition further comprises one or more chain transfer agent(s).

38. The polymerizable composition of claim 18, wherein the polymerizable composition further comprises one or more solvent(s).

39. The polymerizable composition of claim 18, wherein the composition is suitable for use in a 3-D printing method, an additive manufacturing method, in a photocurable thermoset application, or any combination thereof.
